(19) United States
(12) Patent Application Publication
(10) Pub. No.: US 2025/0344206 A1
(43) Pub. Date: Nov. 6, 2025

(54) MANAGEMENT OF LOGICAL CHANNEL PRIORITIZATION FOR CU-UP OVERLOAD

(71) Applicant: Dell Products L.P., Round Rock, TX (US)

(72) Inventor: Hemant Kumar Bhawarlal Jain, Bangalore (IN)

(21) Appl. No.: 18/656,337

(22) Filed: May 6, 2024

(51) Int. Cl. H04W 72/1268; H04W 72/0453; H04W 72/52

(52) U.S. Cl. CPC H04W 72/1268; H04W 72/0453; H04W 72/52

(57) ABSTRACT

In connection with congestion in CU-UP, LCP can be managed. With regard to first CU-UP and second CU-UP associated with a device via first logical channel and second logical channel, respectively, congestion detector determines first CU-UP is experiencing, and second CU-UP is not experiencing, a congestion condition. Channel manager can communicate, to the device, allowed logical channel data that can indicate second logical channel is an allowed channel usable by the device for uplink grant for uplink data transmission based on determining first CU-UP is experiencing, and second CU-UP is not experiencing, the congestion condition. Absence of first logical channel information relating to first CU-UP from the allowed logical channel data can indicate use of the first logical channel for uplink grant by the device is disallowed. When congestion condition is resolved, updated allowed logical channel data can indicate first logical channel is allowed for second uplink grant.

### BACKGROUND

Communication networks can enable users to use devices to wirelessly connect to a communication network and communicate with other devices (e.g., wireless devices or other communication devices). A device, such as a mobile device (e.g., smart phone or other mobile wireless device) can connect (e.g., wirelessly connect) to a cell (e.g., cell of a base station) or other access point associated with a radio access network (RAN) to facilitate connection to a communication network. Devices, via connection to the RAN and communication network, can utilize various types of services and applications of or associated with the communication network.

The above-described description is merely intended to provide a contextual overview regarding communication systems, and is not intended to be exhaustive.

### SUMMARY

The following presents a simplified summary in order to provide a basic understanding of some aspects described herein. This summary is not an extensive overview of the disclosed subject matter. It is intended to neither identify key or critical elements of the disclosure nor delineate the scope thereof. Its sole purpose is to present some concepts in a simplified form as a prelude to the more detailed description that is presented later.

In some embodiments, the disclosed subject matter can comprise a method that can comprise determining, by a system comprising at least one processor, that a first central unit user plane node is experiencing a congestion condition and a second central unit user plane node is not experiencing the congestion condition, wherein a device can be associated with the first central unit user plane node via a first logical channel and can be associated with the second central unit user plane node via a second logical channel. The method also can comprise communicating, by the system, allowed logical channel data to the device, wherein the allowed logical channel data can indicate that the second logical channel is an allowed channel usable by the device for an uplink grant for an uplink data transmission based on the determining that the first central unit user plane node is experiencing, and the second central unit user plane node is not experiencing, the congestion condition.

In certain embodiments, the disclosed subject matter can comprise a system that can comprise at least one memory that can store computer executable components, and at least one processor that can execute computer executable components stored in the at least one memory. The computer executable components can comprise a congestion detector that can determine a first central unit user plane node is experiencing a congestion condition and a second central unit user plane node is not experiencing the congestion condition, wherein a user equipment can be connected to the first central unit user plane node via a first channel and can be connected to the second central unit user plane node via a second channel. The computer executable components also can comprise a channel manager that can communicate allowed channel data to the user equipment, wherein the allowed channel data can indicate that the second channel can be an allowed channel usable by the user equipment for an uplink grant for an uplink data transmission based on the determination that the first central unit user plane node is experiencing, and the second central unit user plane node is not experiencing, the congestion condition.

In still other embodiments, the disclosed subject matter can comprise a non-transitory machine-readable medium, comprising executable instructions that, when executed by at least one processor, can facilitate performance of operations. The operations can comprise receiving, from a distributed unit, allowed logical channel data that can indicate a second logical channel between a device and a second central unit user plane node is an allowed logical channel, wherein the allowed logical channel data is determined based on a determination that a first central unit user plane node is experiencing, and the second central unit user plane node is not experiencing, an overload condition, and wherein the allowed logical channel data does not contain first logical channel information relating to a first logical channel between the device and the first central unit user plane node to indicate that the first logical channel is restricted. The operations also can comprise: in response to receiving an uplink grant, transmitting, via the second logical channel, second data to the second central unit user plane node based on the allowed logical channel data indicating that the second logical channel is the allowed logical channel, wherein the first logical channel is not used to transmit first data from the device to the first central unit user plane node based on the allowed logical channel data indicating that the first logical channel is restricted.

The following description and the annexed drawings set forth in detail certain illustrative aspects of the subject disclosure. These aspects are indicative, however, of but a few of the various ways in which the principles of various disclosed aspects can be employed and the disclosure is intended to include all such aspects and their equivalents. Other advantages and features will become apparent from the following detailed description when considered in conjunction with the drawings.

### BRIEF DESCRIPTION OF THE DRAWINGS

FIG. 1 illustrates a block diagram of a non-limiting example system that can desirably perform and manage logical channel prioritization (LCP), and manage and mitigate congestion of central unit-user planes (CU-UPs) in a radio access network (RAN) of a communication network, in accordance with various aspects and embodiments of the disclosed subject matter.

FIG. 2 depicts a block diagram of another non-limiting example system that can desirably perform and manage LCP, and manage and mitigate congestion of CU-UPs in the RAN of the communication network, in accordance with various aspects and embodiments of the disclosed subject matter.

FIG. 3 illustrates a block diagram of a non-limiting example enhanced LCP process flow that can facilitate desirably performing and managing LCP, and managing and mitigating congestion of CU-UPs in the RAN of the communication network, in accordance with various aspects and embodiments of the disclosed subject matter.

FIG. 4 illustrates a block diagram of non-limiting example system that can comprise the RAN, which can comprise a channel manager component that can desirably perform and manage LCP, and manage and mitigate congestion of CU-UPs in the RAN of the communication network, in accordance with various aspects and embodiments of the disclosed subject matter.

FIG. 5 depicts a diagram of a non-limiting example base station that can desirably facilitate connections and communication of information associated with devices, in accordance with various aspects and embodiments of the disclosed subject matter.

FIG. 6 illustrates a diagram of a non-limiting example device that can be operable to engage in a system architecture that facilitates wireless communications according to one or more embodiments described herein, in accordance with various aspects and embodiments of the disclosed subject matter.

FIG. 7 illustrates a flow chart of an example method that can desirably perform and manage LCP, and manage and mitigate congestion of CU-UPs in a RAN of a communication network, in accordance with various aspects and embodiments of the disclosed subject matter.

FIG. 8 depicts a flow chart of another example method that can desirably perform and manage LCP, and manage and mitigate congestion of CU-UPs in a RAN of a communication network, in accordance with various aspects and embodiments of the disclosed subject matter.

FIG. 9 illustrates a flow chart of an example method that can desirably determine and select an allowed logical channel(s) associated with a CU-UP(s) that can be utilized for an uplink grant for an uplink data transmission, and not select a restricted logical channel(s) associated with another CU-UP(s), to facilitate mitigating congestion in the other CU-UP(s), in accordance with various aspects and embodiments of the disclosed subject matter.

FIG. 10 illustrates an example block diagram of an example computing environment in which the various embodiments of the embodiments described herein can be implemented.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

This disclosure relates generally to management of logical channel prioritization (LCP) in connection with network congestion on a central unit-user plane (CU-UP) of a radio access network (RAN) of a communication network (e.g., communication network comprising a core network that can facilitate wireless communication of information between devices, including wireless devices). A device, such as a mobile device (e.g., user equipment (UE), smart phone, or other mobile wireless device) can connect (e.g., wirelessly connect) to a cell (e.g., cell of a base station) or other access point associated with the RAN of the communication network to facilitate connection to the communication network. The device, via connection to the RAN and communication network, can utilize various types of services and applications of or associated with the communication network, and can simultaneously or concurrently access multiple services.

With regard to fifth generation (5G) or other new radio (NR) generation (e.g., xG, wherein x can be a number greater than 5), a RAN can comprise one or more base stations, such as a gNodeB (gNB), wherein the base station can be disaggregated into a CU-UP (e.g., gNB-CU-UP), a CU-control plane (CP) (e.g., gNB-CU-CP), and a distributed unit (DU) (e.g., gNB-DU). The CU-UP and DU can be part of the user plane node, with the CU-UP hosting packet data convergence protocol (PDCP) and service data adaption protocol (SDAP) entities, and the DU can host the radio link control (RLC), medium access control (MAC), and physical (PHY) layers.

In some instances, when the device is using one or more services, the device can be connected to multiple CU-UPs. Some cases where the device can be utilizing services hosted on different CU-UPs can comprise or relate to, for example, network slicing, quality of service (QOS)-based CU-UP, and/or CU-UP load balancing. With regard to network slicing, a device can connect to up to eight network slices, and each of these network slices can be hosted on a different CU-UP. Regarding QoS-based CU-UP selection, a CU-UP can perform CU-UP selection based at least in part on QoS. In a case when different QoS are handled by different CU-UPs, this can result in the device being connected to multiple CU-UPs (e.g., device using a first service and having a first QoS can be connected to a first CU-UP that can handle the first QoS, and the device using a second service and having a second QoS also can be connected to a second CU-UP that can handle the second QoS). With regard to load balancing, a CU-UP load balancing algorithm employed by CU-UPs can result in a case where certain protocol data unit (PDU) sessions for the same device can be hosted on different CU-UPs. For example, when a new PDU session is being added for a device, the existing CU-UP associated with the device may be overloaded, and, due to such overloading of that CU-UP, the new PDU session can be allocated to another CU-UP. In addition to these example cases, there can be other instances where a device can be associated with multiple CU-UPs at the same time.

When a CU-UP detects an overload condition (e.g., a congestion condition), the CU-UP can take action to mitigate the overload condition. This can include discarding uplink PDU sent by the DU, which can lead to undesirable wastage of air interface resources.

With some existing techniques, to reduce or minimize wastage of air interface resources, the CU-UP can indicate the congestion status indicating the overload condition of the CU-UP to the DU. With some existing techniques, in response to receiving the congestion status from the CU-UP, the DU can deprioritize the scheduling of uplink grants for the device(s) associated with (e.g., belonging to or connected to) the overloaded CU-UP. However, with such existing techniques, if the device is connected to a non-overloaded CU-UP(s), in addition to being connected to the overloaded CU-UP, the DU deprioritizing the scheduling of uplink grants for the device associated with the overloaded CU-UP can undesirably (e.g., unwanted, unacceptable, inefficient, or suboptimal) result in deprioritization of the service(s) of the device that is hosted on the other non-overloaded CU-UP(s) (e.g., the DU deprioritizing the scheduling of uplink grants for the device can undesirably result in deprioritizing of the scheduling of uplink grants for the device with respect to not only the overloaded CU-UP, but with respect to all CU-UPs associated with the device, including the one or more non-overloaded CU-UPs associated with the device).

The disclosed subject matter can address and overcome these and other deficiencies and challenges of the existing techniques with regard to responding to congestion in CU-UPs and deprioritizing scheduling of uplink grants for devices associated with overloaded CU-UPs. In that regard, it can be desirable (e.g., wanted, useful, efficient, advantageous, or optimal) to have a DU be able to deprioritize scheduling of uplink grants for a device with respect to an overloaded CU-UP without deprioritizing scheduling of uplink grants for the device with respect to a non-overloaded CU-UP, while also mitigating (e.g., reducing or minimizing) undesirable wastage of air interface resources that can result from the overloaded CU-UP taking action to mitigate its overload condition.

The disclosed subject matter can employ enhanced LCP and CU-UP overload mitigation techniques that can enable a DU to be able to deprioritize and/or restrict a logical channel(s) associated with an overloaded CU-UP associated with a device, while prioritizing and/or allowing another logical channel(s) associated with a non-overloaded CU-UP associated with the device, and while also mitigating (e.g., reducing or minimizing) undesirable wastage of air interface resources that can result from the overloaded CU-UP taking action to mitigate its overload condition.

To that end, techniques that can desirably (e.g., automatically, dynamically, suitably, reliably, efficiently, enhancedly, and/or optimally) perform and manage LCP, and manage and mitigate congestion (e.g., overloading) of CU-UPs of a RAN, are presented. A system can comprise a communication network that can comprise a core network and one or more RANs that can be associated with (e.g., communicatively connected to) the core network. A RAN can comprise a CU-CP, a group of CU-UPs, and a group of DUs. A DU can comprise or be associated with a channel manager component that can desirably perform and manage LCP for devices associated with the DU and CU-UPs of the group of CU-UPs, in accordance with defined LCP management criteria, while the system also can facilitate (e.g., enable) mitigation (e.g., reduction or minimization) of a congestion condition of a congested CU-UP mitigate while also mitigating undesirable wastage of air interface resources that may result from the congested CU-UP taking action to mitigate its overload condition.

In some embodiments, with regard to a first CU-UP and a second CU-UP associated with a device via a first logical channel and a second logical channel, respectively, a channel manager component, employing a congestion detector component, can determine that the first CU-UP is experiencing, and the second CU-UP is not experiencing, a congestion condition. The channel manager component can determine allowed logical channel data (e.g., an allowed logical channel list) that can indicate the second logical channel can be an allowed logical channel usable by the device for an uplink grant for an uplink data transmission based at least in part on determining that the first CU-UP is experiencing the congestion condition, and the second CU-UP is not experiencing a congestion condition. In some embodiments, absence of first logical channel information relating to the first CU-UP from the allowed logical channel data can indicate use of the first logical channel for the uplink grant by the device can be restricted (e.g., disallowed or deprioritized). In other embodiments, the allowed logical channel data can comprise the first logical channel information relating to the first CU-UP and a restricted indicator (e.g., restricted flag or other indicator) associated with the first logical channel information that can indicate the first logical channel is the restricted logical channel with respect to the uplink grant. The channel manager component can communicate, to the device, the allowed logical channel data.

The device, employing a channel selector component, can determine that the second logical channel can be an allowed logical channel that can be utilized for the uplink grant, and the first logical channel can be the restricted logical channel not to be utilized for the uplink grant, based at least in part on the results of analyzing the allowed logical channel data. Accordingly, the device can select the second logical channel for the uplink grant, and can determine that the first logical channel is not to be selected for the uplink grant, and can communicate data via the second logical channel to the DU and associated second CU-UP.

When congestion condition associated with the first CU-UP is determined to be resolved by the channel manager component, the channel manager component can determine and generate updated allowed logical channel data that can indicate the first logical channel and the second logical channel associated with the second CU-UP can be allowed logical channels for a subsequent uplink grant for a subsequent uplink data transmission by the device. The channel manager component can communicate the update allowed logical channel data to the device to facilitate selection of the first logical channel and/or the second logical channel, by the device, for the subsequent uplink grant.

The disclosed subject matter, by employing the channel manager component and the techniques described herein, can desirably (e.g., suitably, efficiently, enhancedly, or optimally) perform and manage enhanced LCP with respect to logical channels and uplink grant scheduling associated with devices, as compared to existing techniques for uplink grant scheduling for devices, including the prioritization and deprioritization of the uplink grant scheduling. The disclosed subject matter, by employing the channel manager component, the enhanced LCP, and the techniques described herein, can thereby desirably (e.g., suitably, enhancedly, efficiently, or optimally) mitigate (e.g., reduce or minimize) congestion in CU-UPs (and/or other parts of the communication network), mitigate wastage of resources (e.g., by CU-UPs or other network components), and mitigate discarding of data (e.g., by CU-UPs or other network components), as compared to existing techniques for prioritization and deprioritization of the uplink grant scheduling for devices and handling of congestion in CU-UPs. The disclosed subject matter, by employing the channel manager component, the enhanced LCP, and the techniques described herein, also can thereby enhance QoS and/or other performance associated with the device and/or service(s) associated therewith, and quality of experience (QoE) for the user of the device.

These and other aspects and embodiments of the disclosed subject matter will now be described with respect to the drawings.

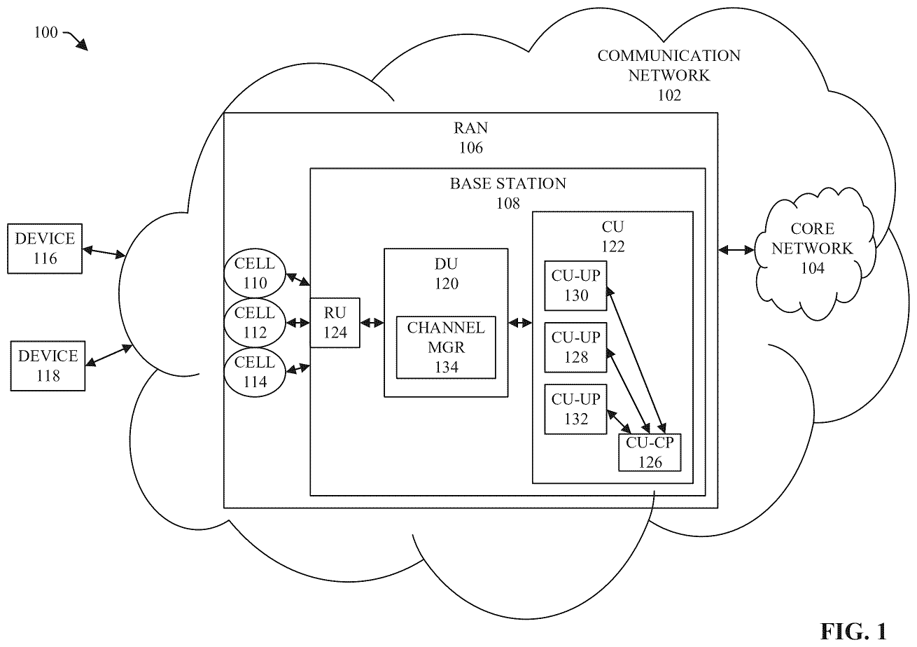

Referring now to the drawings, FIG. 1 illustrates a block diagram of a non-limiting example system 100 that can desirably (e.g., automatically, dynamically, suitably, reliably, efficiently, enhancedly, and/or optimally) perform and manage LCP, and manage and mitigate congestion (e.g., overloading) of CU-UPs in a RAN of a communication network, in accordance with various aspects and embodiments of the disclosed subject matter. The system 100 can comprise a communication network 102 that can comprise a core network 104 and one or more RANs, such as RAN 106, that can be associated with (e.g., communicatively connected to) the core network 104. Each RAN (e.g., RAN 106) can comprise one or more base stations, such as, for example, base station 108, that each can comprise one or more cells, such as cell 110, cell 112, and/or cell 114. In some embodiments, cells 110, 112, and 114 can be associated with the base station 108, and/or other cells can be associated with another base station of the RAN 106.

The core network 104, the one or more RANs (e.g., RAN 106), the one or more base stations (e.g., base station 108), and the one or more cells (e.g., cells 110, 112, and/or 114) can facilitate (e.g., enable) wireless communication of data (e.g., voice or other audio data, video data, textual data, or other data) between devices (e.g., communication devices or UEs), such as devices associated with the core network 104, via the one or more RANs, one or more base stations, and one or more cells, and other devices associated with the core network 104 or, more generally, the communication network 102 (e.g., a device, such as a server or computer, can be connected to the communication network 102 via a wireline connection or via a network other than the core network 104).

The devices can comprise, for example, devices 116 and/or 118. A device (e.g., 116 or 118) can be, for example, a wireless, mobile, or smart phone, a computer, a laptop computer, a server, an electronic pad or tablet, a virtual assistant (VA) device, electronic eyewear, an electronic watch, or other electronic bodywear, an electronic gaming device, an Internet of Things (IoT) device (e.g., a health monitoring device, a toaster, a coffee maker, blinds, a music player, speakers, a telemetry device, a smart meter, a machine-to-machine (M2M) device, or other type of IoT device), a device of a connected vehicle (e.g., car, airplane, train, rocket, and/or other at least partially automated vehicle (e.g., drone)), a personal digital assistant (PDA), a dongle (e.g., a universal serial bus (USB) or other type of dongle), a communication device, or other type of device. In some embodiments, the non-limiting term user equipment (UE) can be used to describe the device. The device (e.g., 116 or 118) can be associated with (e.g., communicatively connected to) the communication network 102 via a communication connection and channel, which can include a wireless or wireline communication connection and channel.

In accordance with various embodiments, the core network 104 can comprise various network components that can facilitate wireless communication of data. In some embodiments, the RAN 106 can be a 5G or other NR RAN (e.g., gNB or other NR-type or xG RAN, wherein x can be a number greater than 5), and/or the base station(s) (e.g., base station 108) can be a 5G or other NR base station (e.g., gNB or other NR-type or xG base station, wherein x can be a number greater than 5). In certain embodiments, the core network 104 can comprise a UPF node, an access and mobility management function (AMF) node, and/or other network functions (not shown in FIG. 1 for reasons of brevity and clarity). The UPF node can connect to or interface with the one or more RANs (e.g., RAN 106) and the one or more base stations (e.g., base station 108), can be an interconnect point between the core network 104 and a data network (DN), can provide or facilitate providing a PDU session anchor point for providing mobility associated with radio access technologies (RATs), can provide or facilitate providing data packet routing or forwarding, and/or can perform or manage other functions. The AMF node can be a control plane function that can manage registration and deregistration of devices (e.g., devices 116 and/or 118) with the core network 104, manage connections of devices with the core network 104, manage mobility associated with devices (e.g., maintain knowledge of locations of devices, update locations of devices), and/or manage or perform other functions. In accordance with various other embodiments, the RAN(s) (e.g., RAN 106) and/or the base station(s) (e.g., base station 108) can be a 4th generation (4G) long term evolution (LTE) RAN or base station, or the RAN or base station can comprise 4G LTE technology and functions, and 5G or other NR-type or xG technology and functions.

The communication network 102, more generally, or the core network 104 can comprise various other network equipment (e.g., routers, gateways, transceivers, switches, access points, network functions, processor components, data stores, or other devices or network nodes) that facilitate (e.g., enable) communication of information between respective items of network equipment of the communication network 102, and/or communication of information between the one or more devices (e.g., devices 116 and/or 118) and the communication network 102. The communication network 102, including the core network 104, can provide or facilitate wireless or wireline communication connections and channels between the one or more devices (e.g., devices 116 and/or 118), and/or respectively associated services or applications, and the communication network 102. For reasons of brevity or clarity, some of the various network equipment, components, functions, or devices of the communication network may not be explicitly shown or described herein.

At various times, the respective devices (e.g., devices 116 and/or 118) can utilize respective services. The services can comprise or relate to, for example, voice service (e.g., conversational voice services or other voice services), video streaming service, conversational video service, buffered video service, audio streaming service, other type of streaming service, text or messaging service, data service, control message service (e.g., control message service relating to control of communication network functions and operations), signaling service, real time gaming service, interactive gaming service, transmission control protocol (TCP) service, control message service relating to automated or semi-automated vehicles or motorized devices, law enforcement-related service, medical-related service, emergency-related service, military-related service, background traffic service, or other desired types of service. In some embodiments, a service can be an extended reality (XR) service or other type of service that can involve or relate to communication of data bursts comprising PDU sets.

In some embodiments, the RAN 106 can comprise various RAN nodes, including distributed units (DUs), such as DU 120, associated with one or more cells (e.g., cell 110, cell 112, and cell 114, as shown in FIG. 1), one or more CUs, such as CU 122, that can be associated with (e.g., communicatively connected to) the respective DUs (e.g., DU 120), and/or one or more radio units (RUs), such as RU 124, that can be associated with the CU(s) 122, and/or other components. In some embodiments, a base station(s) (e.g., base stations 108) of the RAN 106, which also can be referred to as a gNodeB (gNB), can be logically divided into several components, which can allow for flexibility of deployment. For instance, the base station (e.g., base station 108) can comprise a DU(s) 120, which also can be referred to as gNB-DU, the CU 122, which also can be referred to as gNB-CU, and the RU 124, which also can be referred to as gNB-RU. The CU 122 can comprise a CU-CP 126, which also can be referred to as gNB-CU-CP, and a desired number of CU-UPs, such as CU-UP 128, CU-UP 130, and CU-UP 132, which also can be referred to as gNB-CU-UPs, that can be associated with (e.g., communicatively connected to) the CU-CP 126. The DU 120 can be associated with (e.g., communicatively connected to) the CU 122. The CU 122 also can be associated with (e.g., communicatively connected to) the RU 124.

As disclosed, there can be instances where a device can be using one or more services, where the device can be connected to multiple CU-UPs via respective logical channels. For instance, when a device is utilizing the one or more services and the device is to be connected to respective CU-UPs, the base station can establish (e.g., create or generate) respective logical channels between the device and the respective CU-UPs.

In some instance, a CU-UP can experience a congestion (e.g., overload) condition while connected to the device. If the CU-UP detects a congestion condition, the CU-UP can take action to mitigate the congestion condition, such as, for example, discarding uplink PDU sent by the DU, which can lead to undesirable wastage of air interface resources. With some existing techniques, to mitigate wastage of air interface resources, the congested CU-UP can indicate the congestion status, which can indicate the congestion condition of the congested CU-UP, to the DU. With some existing techniques, in response to receiving the congestion status from the CU-UP, the DU can deprioritize the scheduling of uplink grants for the device(s) associated with (e.g., belonging to or connected to) the overloaded CU-UP. However, as disclosed, with such existing techniques, if the device is connected to a non-congested CU-UP(s), in addition to being connected to the congested CU-UP, the DU deprioritizing the scheduling of uplink grants for the device associated with the congested CU-UP can undesirably (e.g., unwanted, unacceptable, inefficient, or suboptimal) result in deprioritization of the service(s) of the device that is hosted on the other non-congested CU-UP(s). For example, the DU deprioritizing the scheduling of uplink grants for the device can undesirably result in deprioritizing of the scheduling of uplink grants for the device with respect to not only the congested CU-UP, but with respect to all CU-UPs associated with the device, including the one or more non-congested CU-UPs associated with the device.

The disclosed subject matter can overcome these deficiencies and other problems of existing techniques. To that end, the system 100 can comprise a channel manager component (CHANNEL MGR) 134 that can desirably (e.g., automatically, dynamically, suitably, reliably, efficiently, enhancedly, and/or optimally) perform and manage enhanced LCP that can enable the DU 120 to be able to deprioritize and/or restrict (e.g., disallow) a logical channel(s) associated with a congested CU-UP (e.g., CU-UP 128) associated with a device (e.g., device 116), while prioritizing and/or allowing another logical channel(s) associated with a non-congested CU-UP (e.g., CU-UPs 130 and/or 132) associated with the device, and while also facilitating mitigation (e.g., reducing or minimizing) of undesirable wastage of air interface resources that can result from the congested CU-UP taking action to mitigate its congestion (e.g., overload) condition, in accordance with the defined LCP management criteria. In some embodiments, the channel manager component 134 can be part of the DU 120 (as depicted), such as described herein. In other embodiments, the channel manager component 134 can be a standalone component or part of another component, such as a controller (e.g., a RAN intelligent controller (RIC) or other type of controller), associated with the RAN(s)), and/or can be located or situated elsewhere in or associated with the communication network 102, wherein the channel manager component 134 can be associated with (e.g., communicatively connected to) the DU 120 and/or CU-UPs (e.g., 128, 130, and/or 132).

In some embodiments, the channel manager component 134 can determine or detect when a CU-UP (e.g., 128) associated with the device (e.g., 116) is experiencing a congestion condition. For instance, the CU-UP 128 associated with (e.g., connected to) the device 116 via a first logical channel (and via the DU 120) can be experiencing the congestion condition, wherein the CU-UP 128 can detect that it is experiencing the congestion condition. The congestion condition can be a level (e.g., amount) of congestion that can satisfy (e.g., can meet or exceed; or can be at or greater than) a defined threshold congestion level. The CU-UP 128 can communicate congestion information (e.g., a congestion indicator) to the DU 120, wherein the congestion information can indicate that the CU-UP 128 is experiencing the congestion condition. Based at least in part on the congestion information received from the CU-UP 128, the channel manager component 134 can determine or detect that the CU-UP 128 is experiencing the congestion condition. The channel manager component 134 also can determine that the CU-UP 130 and CU-UP 132, which be associated with the device 116 via a second logical channel and a third logical channel, respectively, (and via the DU 120) are not experiencing a congestion condition, based at least in part on the DU 120 not receiving congestion information indicating a congestion condition, from the CU-UP 130 or CU-UP 132. For example, the CU-UP 130 and CU-UP 132 each can have congestion levels that do not satisfy (e.g., do not meet; or can be lower or less than) the defined threshold congestion level.

Based at least in part on determining that the CU-UP 128 is experiencing the congestion condition, and the CU-UPs 130 and 132 are not experiencing a congestion condition, the channel manager component 134 can determine and generate allowed logical channel data (e.g., an allowed logical channel list) that can indicate the second logical channel associated with the CU-UP 130 and the third logical channel associated with the CU-UP 132 are allowed logical channels that can be usable by the device 116 for an uplink grant(s) for an uplink data transmission(s), in accordance with the defined LCP criteria. The allowed logical channel data also can indicate that the first logical channel associated with the CU-UP 128 (e.g., the congested CU-UP) can be a restricted (e.g., disallowed) logical channel with respective to the device 116, based at least in part on the absence of first logical channel information relating to the first logical channel from the allowed logical channel data, wherein such absence of the first logical channel information from the allowed logical channel data can indicate that the first logical channel is not an allowed logical channel with respect to the device 116 (e.g., the device 116 cannot use the first logical channel for the uplink grant(s) for the uplink data transmission(s)). It is to be appreciated and understood that, in certain embodiments, instead of omitting the first logical channel information from the allowed logical channel data to indicate that the first logical channel is a restricted logical channel with respect to the device 116, the allowed logical channel data, in addition to comprising information (e.g., second logical channel information relating to the second logical channel and third logical channel information relating to the third logical channel), can comprise the first logical channel information relating to the first logical channel associated with (e.g., linked or mapped to) a restricted indicator (e.g., a restricted or disallowed flag or other type of restricted or disallowed indicator) that can indicate or specify that the first logical channel is the restricted channel with respect to the device 116. In such embodiments, the second logical channel information and third logical channel information can (or may not) be associated with an allowed indicator (e.g., an allowed or permitted flag or other type of allowed or permitted indicator) that can indicate that the second logical channel and the third logical channel are allowed logical channels that can be usable by the device 116 for the uplink grant(s).

The channel manager component 134 can communicate the allowed logical channel data to the device 116. Based at least in part on the allowed logical channel data indicating that the second logical channel and the third logical channel are the allowed logical channels, and the first logical channel is a restricted logical channel, when the device 116 receives the uplink grant from the DU 120, the device 116 can utilize the second logical channel and/or the third logical channel for the uplink grant for the uplink transmission of data via the CU-UP 130 and CU-UP 132 (and the DU 120), and will not use the first logical channel associated with the CU-UP 128 (e.g., the congested CU-UP) for the uplink grant, in accordance with the defined LCP management criteria. The channel manager component 134, by restricting (e.g., disallowing or deprioritizing uplink grants with respect to) the first logical channel associated with the CU-UP 128 with respect to the device 116 (and/or the logical channel associated with the CU-UP 128 with respect to another device(s)), can desirably mitigate the congestion condition being experienced by the CU-UP 128. Also, the channel manager component 134, by allowing desired uplink grant scheduling for uplink data transmissions with respect to the second logical channel associated with the CU-UP 130 and the device 116, and the third logical channel associated with the CU-UP 132 and the device 116 (and/or allowing other allowed logical channels associated with the other device(s) and CU-UPs 130 and/or 132), can facilitate (e.g., enable) desirable (e.g., suitable, acceptable, useful, wanted, or optimal) communication of data using the second and third logical channels, and desirable use of the one or more services associated with the second and third logical channels by the device 116 and/or associated user, and can enhance QoS and/or other performance associated with the device 116 and/or service(s) associated therewith, and QoE for the user of the device 116.

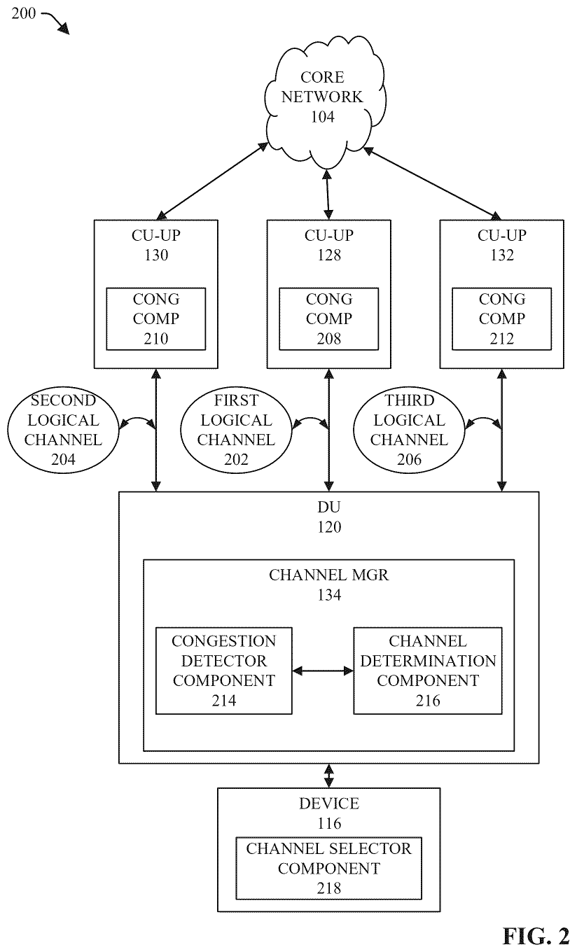

Referring to FIG. 2 (along with FIG. 1), FIG. 2 depicts a block diagram of a non-limiting example system 200 that can desirably (e.g., automatically, dynamically, suitably, reliably, efficiently, enhancedly, and/or optimally) perform and manage LCP, and manage and mitigate congestion of CU-UPs (e.g., 128, 130, and/or 132) in the RAN 106 of the communication network 102, in accordance with various aspects and embodiments of the disclosed subject matter. In some embodiments, the system 200 can be part of (e.g., a portion of) the system 100 of FIG. 1.

The system 200 can comprise the core network 104, the DU 120, and the CU-UPs 128, 130, and 132. The CU-UPs 128, 130, and 132 can be associated with (e.g., communicatively connected to) the core network 104 via respective connection or channels. The CU-UPs 128, 130, and 132 also can be associated with (e.g., communicatively connected to) the DU 120 via respective connection or channels. The device 116 can be associated with (e.g., communicatively connected to) the DU 120 to utilize or communicate with one or more services and/or communicate with one or more other communication devices (e.g., device 118, or other device or server of or associated with the communication network 102 and/or core network 104). In certain embodiments, the device 116 can be associated with multiple CU-UPs simultaneously or concurrently (e.g., at the same time) to facilitate utilizing the one or more services and/or communicating with the one or more other communication devices. For instance, the device 116, via the DU 120, can be associated with (e.g., communicatively connected to) the CU-UP 128 via a first logical channel 202, the CU-UP 130 via a second logical channel 204, and the CU-UP 132 via a third logical channel 206.

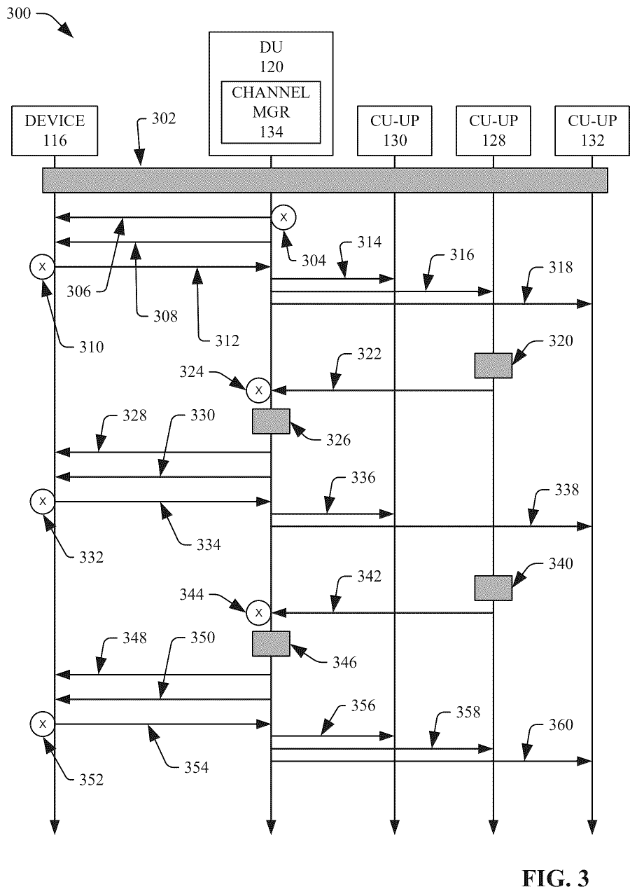

Referring to FIG. 3 (along with FIGS. 1 and 2), FIG. 3 illustrates a block diagram of a non-limiting example enhanced LCP process flow 300 that can facilitate desirably (e.g., automatically, dynamically, suitably, reliably, efficiently, enhancedly, and/or optimally) performing and managing LCP, and managing and mitigating congestion of CU-UPs (e.g., 128, 130, and/or 132) in the RAN 106 of the communication network 102, in accordance with various aspects and embodiments of the disclosed subject matter. As a non-limiting example, the device 116 can be associated with the CU-UP 128 via the first logical channel 202 (e.g., logical channel identifier (ID) 6) with regard to a first PDU session and a first service, the CU-UP 130 via a second logical channel 204 (e.g., logical channel ID 5) with regard to a second PDU session and a second service, and the CU-UP 132 via a third logical channel 206 (e.g., logical channel ID 7) with regard to a third PDU session and a third service, as indicated at reference numeral 302 of the enhanced LCP process flow 300. It is to be appreciated and understood that, in other embodiments, the device 116 can be associated with less or more than three CU-UPs, can be associated with less or more than three services, and/or the data sessions can be another type(s) of data session.

The CU-UPs 128, 130, and 132 each can comprise respective congestion components, such as congestion component (CONG COMP) 208, congestion component 210, and congestion component 212, respectively, that can monitor for and detect when the CU-UPs 128, 130, and 132 are experiencing congestion conditions or are not experiencing congestion conditions. In certain embodiments, the respective congestion components 208, 210, and 212 can perform functions and operations to mitigate (e.g., reduce, minimize, or eliminate) respective congestion conditions in or associated with the respective CU-UPs 128, 130, and 132. For example, in response to the congestion component 208 detecting a congestion condition in the CU-UP 128, the congestion component 208 can communicate a congestion indicator to the DU 120 to indicate that the CU-UP 128 is experiencing the congestion condition to facilitate deprioritization (e.g., logical channel deprioritization or restriction) of uplink grant scheduling of devices by the DU 120 to mitigate congestion at the CU-UP 128, can discard uplink PDU sent by the DU 120, and/or can take other mitigation action to mitigate the congestion condition at the CU-UP 128.

In a non-limiting example scenario, initially, the CU-UPs 128, 130, and 132 can be operating such that they are not experiencing congestion conditions. For instance, based on the respective monitoring of congestion levels associated with the respective CU-UPs 128, 130, and 132, the respective congestion components 208, 210, and 212 of the respective CU-UPs 128, 130, and 132 can determine that the respective congestion levels of the respective CU-UPs 128, 130, and 132 do not satisfy the defined threshold congestion level, which can indicate whether there is a congestion condition associated with a CU-UP.

In certain embodiments, the channel manager component 134 can comprise a congestion detector component 214 that can monitor the respective CU-UPs 128, 130, and 132 to detect or determine whether any of the respective CU-UPs 128, 130, and 132 are experiencing a congestion condition. In this example scenario, at this point, in some embodiments, the congestion detector component 214 can receive no congestion information from the respective CU-UPs 128, 130, and 132, wherein receiving no congestion information can indicate that no congestion condition exists (e.g., no congestion condition has been detected) with regard to the respective CU-UPs 128, 130, and 132. In other embodiments, the congestion detector component 214 can receive not-congested information (e.g., a not-congested indicator or flag) from the respective CU-UPs 128, 130, and 132 to indicate that no congestion condition exists with regard to the respective CU-UPs 128, 130, and 132.

The channel manager component 134 can comprise a channel determination component 216 that can determine whether a logical channel associated with a CU-UP and a device can be an allowed logical channel or is to be a restricted logical channel with respect to the device, based at least in part on a determination of whether the CU-UP is experiencing a congestion condition. If, due to not receiving congestion information indicating a congestion condition from the CU-UP or due to receiving not-congested information from the CU-UP, the congestion detector component 214 determines that no congestion exists with regard to the CU-UP (e.g., CU-UP 128), the channel determination component 216 can determine that the logical channel (e.g., the first logical channel (e.g., logical channel 6)) associated with the CU-UP and the device (e.g., 116) can be an allowed logical channel that can be utilized by the device for an uplink grant for an uplink data transmission (e.g., via the DU 120 and that CU-UP 128). If, instead, due to receiving congestion information indicating a congestion condition exists from the CU-UP, the congestion detector component 214 determines or detects that the congestion condition exists with regard to the CU-UP, the channel determination component 216 can determine that the logical channel associated with the CU-UP and the device is to be a restricted logical channel that can be restricted or disallowed from being utilized by the device for the uplink grant for the uplink data transmission.

In this example scenario, since, at this point, the CU-UPs 128, 130, and 132 are not experiencing a congestion condition, based at least in part on the monitoring of the CU-UPs indicating that no congestion condition is detected with regard to the CU-UPs 128, 130, and 132 (e.g., based at least in part on no congestion indicator being received, or based at least in part on not-congested indicators being received, from the CU-UPs 128, 130, and 132), the congestion detector component 214 can determine that no congestion exists with regard to the CU-UPs 128, 130, and 132. As a result of the congestion detector component 214 determining that no congestion exists with regard to the CU-UPs 128, 130, and 132, the congestion detector component 214 can indicate to the channel determination component 216 that no congestion exists with regard to the CU-UPs 128, 130, and 132. As a result of that indication that no congestion exists with regard to the CU-UPs 128, 130, and 132, the channel determination component 216 can determine, and can generate allowed logical channel data indicating or specifying, that the first logical channel 202 (e.g., logical channel identifier 6) associated with the CU-UP 128, the second logical channel 204 (e.g., logical channel 5) associated with the CU-UP 130, and the third logical channel 206 (e.g., logical channel 7) associated with the CU-UP 132 can be allowed logical channels for the device 116, as indicated at reference numeral 304 of the enhanced LCP process flow 300. The channel manager component 134 can communicate the allowed logical channel data to the device 116, as indicated at reference numeral 306 of the enhanced LCP process flow 300.

In this example scenario, subsequent to the device 116 receiving the allowed logical channel data, the DU 120 can communicate an uplink grant to the device 116, which can receive the uplink grant, as indicated at reference numeral 308 of the enhanced LCP process flow 300. The uplink grant can provide the device 116 uplink grant information and/or resource information (e.g., information relating to allocated resources) for the device 116 to utilize to communicate data during an uplink data transmission, in accordance with the uplink grant. The device 116, employing a channel selector component 218, can determine and select allowed logical channels for the uplink grant, based at least in part on the results of analyzing the allowed logical channel data, as indicated at reference numeral 310 of the enhanced LCP process flow 300. In this example scenario, based at least in part on the results of analyzing the allowed logical channel data, the channel selector component 218 can determine that the first logical channel 202 (e.g., logical channel identifier 6), the second logical channel 204 (e.g., logical channel 5), and the third logical channel 206 (e.g., logical channel 7) can be allowed logical channels for the uplink grant, and can select those allowed logical channels or the uplink grant. The device 116, using the allowed logical channels (e.g., the first logical channel 202, the second logical channel 204, and the third logical channel 206), can communicate uplink data to the DU 120, in accordance with the uplink grant, as indicated at reference numeral 312 of the enhanced LCP process flow 300. The uplink data can comprise respective uplink data that is to be communicated to the respective CU-UPs 128, 130, and 132 via the respective first, second, and third logical channels 202, 204, and 206.

It is to be appreciated and understood that the device 116 (e.g., the channel selector component 218 of the device 116) does not have to utilize all of the allowed logic channels for the uplink grant. For instance, if, at the time of the uplink grant, the device 116 does not have any uplink data to communicate to a particular CU-UP (e.g., 130) associated with a particular allowed logic channel (e.g., second logical channel), the device 116 can determine that the particular allowed logic channel does not have to be, or is not to be, selected for the uplink grant.

In response to receiving the uplink data, comprising respective uplink data (e.g., respective portions of uplink data) from the device 116, the DU 120 can communicate the respective uplink data to the respective CU-UPs 128, 130, and 132 via the respective first, second, and third logical channels 202, 204, and 206, as indicated at reference numerals 314, 316, and 318 of the enhanced LCP process flow 300. The respective CU-UPs 128, 130, and 132 can forward (e.g., communicate) the respective uplink data to respective destinations (e.g., respective services or associated communication devices) via the core network 104 and/or the communication network 102 (e.g., another portion of the communication network 102).

In this example scenario, at a subsequent point in time, the CU-UP 128 can begin experiencing a congestion (e.g., overload) condition. The respective congestion components 208, 210, and 212 of the respective CU-UPs 128, 130, and 132 can continue to monitor congestion levels associated with the respective CU-UPs 128, 130, and 132. At the subsequent point in time, the congestion component 208 can detect or determine that the CU-UP 128 is experiencing the congestion condition (e.g., has a congestion level that satisfies the defined threshold congestion level), as indicated at reference numeral 320 of the enhanced LCP process flow 300. The respective congestion components 210 and 212 can continue to determine that no congestion condition exists with respect to the CU-UPs 130 and 132. The CU-UP 128 (e.g., the congestion component 208 of the CU-UP 128) can communicate, to the DU 120, congestion information (e.g., a congestion indicator) that can indicate the CU-UP 128 is experiencing the congestion condition), as indicated at reference numeral 322 of the enhanced LCP process flow 300.

The DU 120 (e.g., the congestion detector component 214 of the DU 120) can determine or detect that the CU-UP 128 is experiencing the congestion condition, based at least in part on the congestion information received from the CU-UP 128, as indicated at reference numeral 324 of the enhanced LCP process flow 300. The congestion detector component 214 also can determine that the CU-UPs 130 and 132 are not experiencing a congestion condition, based at least in part on the monitoring of those CU-UPs 130 and 132 (e.g., based at least in part on not receiving any congestion information that indicates those CU-UPs 130 and 132 are experiencing a congestion condition).

Based at least in part on determining that the CU-UP 128 is experiencing the congestion condition, and CU-UPs 130 and 132 are not experiencing a congestion condition, the channel determination component 216 can determine, and can generate allowed logical channel data (e.g., modified or updated allowed logical channel data) indicating, that the second logical channel 204 associated with the CU-UP 130 and the third logical channel 206 associated with the CU-UP 132 can be allowed logical channels, and the first logical channel 202 associated with the CU-UP 128 can be a restricted logical channel, with respect to an uplink grant (e.g., a next or subsequent uplink grant(s)) for the device 116, as indicated at reference numeral 326 of the enhanced LCP process flow 300. For instance, based at least in part on determining that the CU-UP 128 is experiencing the congestion condition, and CU-UPs 130 and 132 are not experiencing a congestion condition, the channel determination component 216 can determine that uplink grant scheduling for the device 116 via the first logical channel 202 is to be deprioritized (e.g., restricted or disallowed), and uplink grant scheduling for the device 116 via the second logical channel 204 and the third logical channel 206 can be (e.g., can remain) prioritized (e.g., can be allowed or unrestricted; can remain prioritized or at unrestricted prioritization). The DU 120 can communicate the allowed logical channel data (e.g., the modified or updated allowed logical channel data) to the device 116, as indicated at reference numeral 328 of the enhanced LCP process flow 300.

In this example scenario, subsequent to the device 116 receiving the allowed logical channel data (e.g., the modified or updated allowed logical channel data), the DU 120 can communicate an uplink grant (e.g., the next or subsequent uplink grant) to the device 116, which can receive the uplink grant, as indicated at reference numeral 330 of the enhanced LCP process flow 300. The uplink grant can provide the device 116 uplink grant information and/or resource information (e.g., information relating to allocated resources) for the device 116 to utilize to communicate data during an uplink data transmission (e.g., a next or subsequent uplink transmission), in accordance with that uplink grant.

The device 116, employing the channel selector component 218, can determine and select allowed logical channels for the uplink grant, based at least in part on the results of analyzing the allowed logical channel data, as indicated at reference numeral 332 of the enhanced LCP process flow 300. In this example scenario, based at least in part on the results of analyzing the allowed logical channel data, the channel selector component 218 can determine that the second logical channel 204 (e.g., logical channel 5) and the third logical channel 206 (e.g., logical channel 7) can be allowed logical channels for the uplink grant, and can select those allowed logical channels for the uplink grant; and can determine that the first logical channel 202 (e.g., logical channel identifier 6) is a restricted logical channel that is not to be selected or utilized for this uplink grant (e.g., at least with regard to this uplink grant at this time). The device 116, using the allowed logical channels (e.g., the second logical channel 204 and the third logical channel 206), can communicate uplink data to the DU 120, in accordance with the uplink grant, as indicated at reference numeral 334 of the enhanced LCP process flow 300. The uplink data can comprise respective uplink data that is to be communicated to the respective CU-UPs 130 and 132 via the respective second and third logical channels 204 and 206.

In response to receiving the uplink data, comprising respective uplink data (e.g., respective portions of uplink data) from the device 116, the DU 120 can communicate the respective uplink data to the respective CU-UPs 130 and 132 via the respective second and third logical channels 204 and 206, as indicated at reference numerals 336 and 338 of the enhanced LCP process flow 300. The respective CU-UPs 130 and 132 can forward (e.g., communicate) the respective uplink data to respective destinations (e.g., respective services or associated communication devices) via the core network 104 and/or the communication network 102 (e.g., another portion of the communication network 102).

In this example scenario, at a subsequent point in time (e.g., after the CU-UP 128 was determined to be experiencing the congestion condition), the congestion condition of the CU-UP 128 can be resolved. The respective congestion components 208, 210, and 212 of the respective CU-UPs 128, 130, and 132 can continue to monitor congestion levels associated with the respective CU-UPs 128, 130, and 132. At this subsequent point in time, the congestion component 208 can detect or determine that the CU-UP 128 the congestion condition has been resolved (e.g., the congestion level is below the defined threshold congestion level), as indicated at reference numeral 340 of the enhanced LCP process flow 300. The respective congestion components 210 and 212 can continue to determine that no congestion condition exists with respect to the CU-UPs 130 and 132. The CU-UP 128 (e.g., the congestion component 208 of the CU-UP 128) can communicate or indicate, to the DU 120, congestion information that can indicate the congestion condition of the CU-UP 128 has been resolved, as indicated at reference numeral 342 of the enhanced LCP process flow 300. In accordance with various embodiments, the CU-UP 128 can communicate not-congested information (e.g., a not-congested indicator or flag, or a congestion resolution indicator or flag), or can discontinue communicating congested information (e.g., discontinue communicating a congestion condition indicator or flag), to the DU 120 to indicate to or inform the DU 120 that the congestion condition of the CU-UP 128 has been resolved.

The DU 120 (e.g., the congestion detector component 214 of the DU 120) can determine or detect that the congestion condition of the CU-UP 128 has been resolved, based at least in part on the congestion information or indication of the resolution of the congestion condition received from the CU-UP 128, as indicated at reference numeral 344 of the enhanced LCP process flow 300. The congestion detector component 214 also can determine that the CU-UPs 130 and 132 continue to not be experiencing a congestion condition, based at least in part on the monitoring of those CU-UPs 130 and 132 (e.g., based at least in part on not receiving any congestion information that indicates those CU-UPs 130 and 132 are experiencing a congestion condition).

Based at least in part on determining that the congestion condition of the CU-UP 128 has been resolved, and CU-UPs 128, 130, and 132 are not experiencing a congestion condition, the channel determination component 216 can determine, and can generate allowed logical channel data (e.g., modified or updated allowed logical channel data) indicating, that the first logical channel 202 associated with the CU-UP 128, the second logical channel 204 associated with the CU-UP 130, and the third logical channel 206 associated with the CU-UP 132 can be allowed logical channels with respect to an uplink grant (e.g., a next or subsequent uplink grant(s)) for the device 116, as indicated at reference numeral 346 of the enhanced LCP process flow 300. For instance, based at least in part on determining that the CU-UPs 128, 130, and 132 are not experiencing a congestion condition, the channel determination component 216 can determine that uplink grant scheduling for the device 116 via the first logical channel 202 is not to be (e.g., no longer is to be) deprioritized (e.g., restricted or disallowed), and uplink grant scheduling for the device 116 via the second logical channel 204 and the third logical channel 206 can be (e.g., can remain) prioritized (e.g., can be allowed or unrestricted; can remain prioritized or at unrestricted prioritization). That is, the channel determination component 216 can determine that uplink grant scheduling for the device 116 via the first logical channel 202, the second logical channel 204, and the third logical channel 206 can be prioritized (e.g., can be allowed or can have unrestricted prioritization). The DU 120 can communicate the allowed logical channel data (e.g., the modified or updated allowed logical channel data) to the device 116, as indicated at reference numeral 348 of the enhanced LCP process flow 300.

In this example scenario, subsequent to the device 116 receiving the allowed logical channel data (e.g., the modified or updated allowed logical channel data), the DU 120 can communicate an uplink grant (e.g., the next or subsequent uplink grant) to the device 116, which can receive the uplink grant, as indicated at reference numeral 350 of the enhanced LCP process flow 300. The uplink grant can provide the device 116 uplink grant information and/or resource information (e.g., information relating to allocated resources) for the device 116 to utilize to communicate data during an uplink data transmission (e.g., a next or subsequent uplink transmission), in accordance with that uplink grant.

The device 116, employing the channel selector component 218, can determine and select allowed logical channels for the uplink grant, based at least in part on the results of analyzing the allowed logical channel data, as indicated at reference numeral 352 of the enhanced LCP process flow 300. In this example scenario, based at least in part on the results of analyzing the allowed logical channel data, the channel selector component 218 can determine that the first logical channel 202 (e.g., logical channel 6), the second logical channel 204 (e.g., logical channel 5), and the third logical channel 206 (e.g., logical channel 7) can be allowed logical channels for this uplink grant, and can select those allowed logical channels for the uplink grant. The device 116, using the allowed logical channels (e.g., the first logical channel 202, the second logical channel 204, and the third logical channel 206), can communicate uplink data to the DU 120, in accordance with this uplink grant, as indicated at reference numeral 354 of the enhanced LCP process flow 300. The uplink data can comprise respective uplink data that is to be communicated to the respective CU-UPs 128, 130, and 132 via the respective first, second, and third logical channels 202, 204, and 206.

In response to receiving the uplink data, comprising respective uplink data (e.g., respective portions of uplink data) from the device 116, the DU 120 can communicate the respective uplink data to the respective CU-UPs 128, 130, and 132 via the respective first, second, and third logical channels 202, 204, and 206, as indicated at reference numerals 356, 358, and 360 of the enhanced LCP process flow 300. The respective CU-UPs 128, 130, and 132 can forward (e.g., communicate) the respective uplink data to respective destinations (e.g., respective services or associated communication devices) via the core network 104 and/or the communication network 102 (e.g., another portion of the communication network 102).

The channel manager component 134 and other components of the system 100 and/or system 200 can continue to perform their respective functions and operations to facilitate performing managing LCP, facilitate mitigating congestion associated with a CU-UP(s), and facilitate mitigating wastage of resources in connection with a congested CU-UP, utilizing the LCP management techniques and algorithms, in accordance with the defined LCP management criteria, such as described herein.

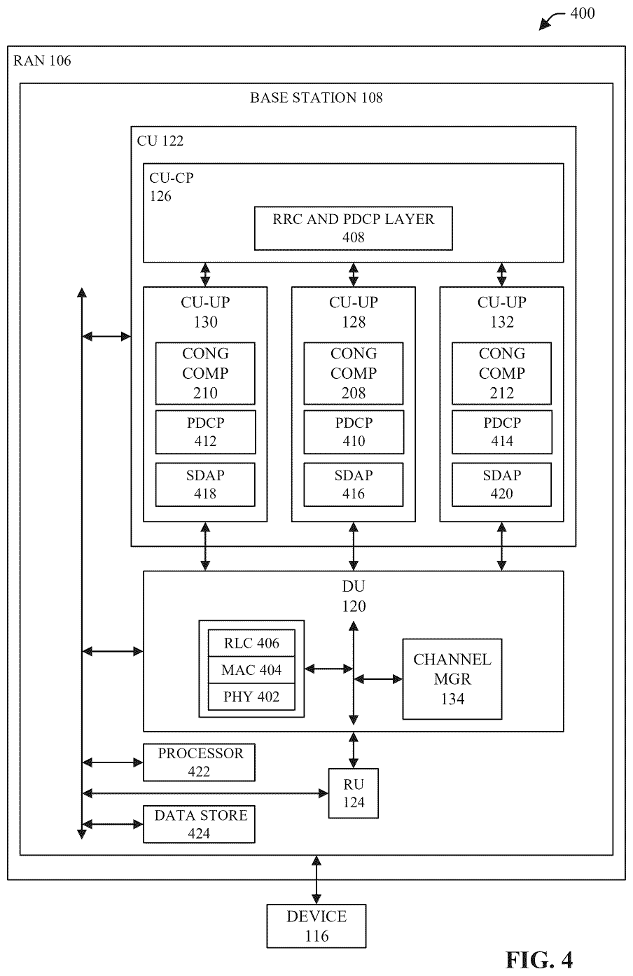

Turning to FIG. 4 (along with FIGS. 1 and 2), FIG. 4 illustrates a block diagram of non-limiting example system 400 that can comprise the RAN 106, which can comprise the channel manager component 134 (e.g., in or associated with the DU 120) that can desirably perform and manage LCP, and manage and mitigate congestion of CU-UPs (e.g., 128, 130, and/or 132) in the RAN 106 of the communication network 102, in accordance with various aspects and embodiments of the disclosed subject matter. In some embodiments, the system 400 can be part of the system 100 depicted in FIG. 1 and/or the system 200 depicted in FIG. 2. The RAN 106 can comprise the base station 108 that can comprise the DU 120, the CU 122, and the RU 124. The CU 122 can comprise the CU-CP 126 and the CU-UPs 128, 130, and 132. The DU 120 can comprise or be associated with the channel manager component 134.

In some embodiments, the RAN 106 can be an open-RAN (O-RAN) that can be part of an O-RAN architecture and environment (e.g., the communication network 102 can employ an O-RAN architecture and environment). In certain embodiments, the RAN 106 can be a cloud-based or centralized RAN (C-RAN) that can be part of a cloud or centralized RAN (C-RAN), or a virtual RAN (vRAN) that can be part of a vRAN architecture and environment (e.g., the communication network 102 can employ a C-RAN or vRAN architecture and environment). In still other embodiments, the RAN 106 may not be an O-RAN, C-RAN, or vRAN.

The DU 120 can be a logical node that can host or handle baseband (e.g., PHY 402) and layer 2 (L2) (e.g., MAC layer 404 and RLC layer 406) functionality associated with the base station. The CU-CP 126 (also referred to as a CU-CP node) can be a logical node that can host or handle layer 3 (L3) (e.g., radio resource control (RRC) and PDCP layer 408) control plane functionality associated with the base station 108. The CU-UPs 128, 130, and 132 (also referred to as a CU-UP nodes) can be logical nodes that can host or handle data traffic between the core network 104 (e.g., 5G core network) and the DUs (e.g., 120) to which the CU-UPs 128, 130, and 132 are connected. The CU-UPs 128, 130, and 132 can comprise respective congestion components 208, 210, and 212 that can monitor for, detect, and mitigate congestion conditions in or associated with the respective CU-UPs 128, 130, and 132, such as described herein. In some embodiments, the CU-UPs 128, 130, and 132 can comprise respective PDCP components (PDCP) 410, 412, and 414 that can perform PDCP functions, and respective SDAP components (SDAP) 416, 418, and 420 that can perform SDAP functions. The RU 124 can be or can comprise a logical node that can host a lower PHY layer and radio frequency (RF) processing, where signals (e.g., RF signals) can be transmitted, received, amplified, digitized, or otherwise processed, to facilitate communication of information (e.g., signals comprising information) between the RAN 106 and other devices (e.g., devices 116 and/or 118) or components (e.g., components or functions of the core network 104 or communication network 102).

In accordance with various embodiments, the DU 120 can comprise the channel manager component 134 that can perform and manage LCP, and can facilitate managing and mitigating congestion of the CU-UPs (e.g., 128, 130, and/or 132) in the RAN 106, in accordance with the defined LCP management criteria, such as described herein. For instance, in response to determining that the CU-UP 128 is experiencing a congestion condition and the CU-UPs 130 and 132 are not experiencing a congestion condition, the channel manager component 134 can desirably restrict (e.g., disallow or deprioritize uplink grants with respect to) the first logical channel 202 associated with the CU-UP 128 with respect to the device 116 to desirably mitigate the congestion condition being experienced by the CU-UP 128, while allowing desired uplink grant scheduling for uplink data transmissions with respect to the second logical channel 204 associated with the CU-UP 130 and the device 116, and the third logical channel 206 associated with the CU-UP 132 and the device 116, in accordance with the defined LCP management criteria, such as described herein.

In certain embodiments, as disclosed, the system 400 can comprise an O-RAN architecture and environment, and the RAN 106 can be an O-RAN. In some embodiments, in the O-RAN architecture and environment, the system 400 also can comprise a service management and orchestration (SMO) component and RIC (not shown in FIG. 4), wherein the SMO component can be associated with (e.g., communicatively connected to) the RIC and/or the RAN 106 (and/or one or more other RANs) via an interface(s) (e.g., an O1 interface, an AI interface, or another interface), to facilitate communication of information between the SMO component and the RIC and/or the RAN 106 (and/or one or more other RANs), and the RIC can be associated with the RAN 106 (and/or one or more other RANs) via an interface(s) (e.g., an E2 interface or another interface), to facilitate communication of information between the RIC and the RAN 106 (and/or one or more other RANs).

The SMO component can act and operate as a management and orchestration layer that can control configuration and automation aspects of the RIC and RAN elements of the RAN(s). The SMO component can comprise various types of management services and various network functions, comprising network management functions, which can include RAN-type or RAN-related functions, core management functions, transport management functions, network slice management functions (e.g., end-to-end network slice management functions), and/or other network management functions. In accordance with various embodiments, the network functions can be or can comprise physical network functions, virtualized network functions (e.g., virtual machines (VMs), containers, or other virtualized network functions). At least some of the various network functions (e.g., network management functions or other network functions) can operate in real time or near real time. The RIC can operate to control (e.g., manage) and enhance (e.g., improve or optimize) RAN functions and services of the RAN(s). At least some of the various network functions and components of the RIC can operate in real time or near real time, and some network functions and components of the RIC may operate in non-real time.

In accordance with various embodiments, the RAN 106 can comprise a processor component 422 that can be associated with (e.g., communicatively connected to) and can work in conjunction with other components of the RAN 106, including the base stations (e.g., 108 and/or 110), the DU(s) (e.g., 120), the CU 122, the RU(s) 124, the channel manager component 134, a data store 424, and/or other components of the RAN 106, to facilitate performing the various functions and operations of the RAN 106. The processor component 422 can employ one or more processors (e.g., one or more central processing units (CPUs)), microprocessors, or controllers that can process information relating to data, files, services, applications, communication networks, RANs, cells, devices, LCP, allowed logical channel data, allowed logical channels, restricted logical channels, resources, congestion information or indicators, PDU session data, congestion levels, threshold values or levels (e.g., threshold congestion level), data processing operations, messages, notifications, alarms, alerts, preferences (e.g., user or client preferences), hash values, metadata, parameters, traffic flows, policies, the defined LCP management criteria, algorithms (e.g., enhanced LCP management algorithms, uplink grant scheduling algorithm(s), downlink scheduling algorithm(s), hash algorithms, data compression algorithms, data decompression algorithms, and/or other algorithm), interfaces, protocols, tools, and/or other information, to facilitate operation of the RAN 106, and control data flow between the RAN 106 and/or other components (e.g., network components, another RAN, the communication network 102, a device (e.g., 116 or 118), a node, a service, a user, or other entity) associated with the RAN 106.

The data store 424 can store data structures (e.g., user data, metadata), code structure(s) (e.g., modules, objects, hashes, classes, procedures) or instructions, information relating to data, files, services, applications, communication networks, RANs, cells, devices, LCP, allowed logical channel data, allowed logical channels, restricted logical channels, resources, congestion information or indicators, PDU session data, congestion levels, threshold values or levels (e.g., threshold congestion level), data processing operations, messages, notifications, alarms, alerts, preferences (e.g., user or client preferences), hash values, metadata, parameters, traffic flows, policies, the defined LCP management criteria, algorithms (e.g., enhanced LCP management algorithms, uplink grant scheduling algorithm(s), downlink scheduling algorithm(s), hash algorithms, data compression algorithms, data decompression algorithms, and/or other algorithm), interfaces, protocols, tools, and/or other information, to facilitate controlling or performing operations associated with the RAN 106. The data store 424 can comprise volatile and/or non-volatile memory, such as described herein. In an aspect, the processor component 422 can be functionally coupled (e.g., through a memory bus) to the data store 424 in order to store and retrieve information desired to operate and/or confer functionality, at least in part, to the base stations (e.g., 108 and/or 110), DU(s) (e.g., 120), CU 122, RU(s) 124, channel manager component 134, processor component 422, data store 424, and/or other component of the RAN 106, and/or substantially any other operational aspects of RAN 106.

As disclosed, the data store 424 can comprise volatile memory and/or nonvolatile memory. By way of example and not limitation, nonvolatile memory can include read only memory (ROM), programmable ROM (PROM), electrically programmable ROM (EPROM), electrically erasable ROM (EEPROM), flash memory, non-volatile memory express (NVMe), NVMe over fabric (NVMe-oF), persistent memory (PMEM), or PMEM-oF. Volatile memory can include random access memory (RAM), which can act as external cache memory. By way of example and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

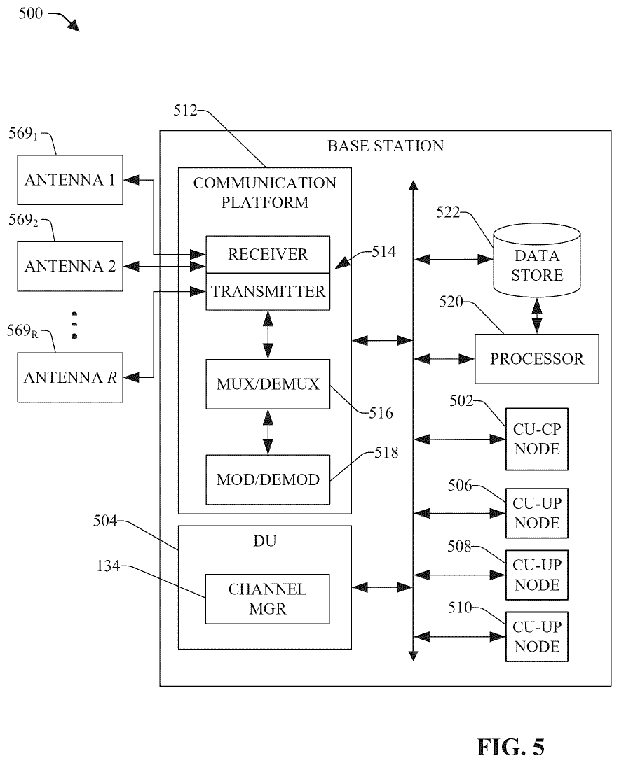

Turning to FIG. 5, FIG. 5 depicts a diagram of a non-limiting example base station 500 that can desirably facilitate (e.g., enable) connections (e.g., wireless connections) and communication of information associated with devices, in accordance with various aspects and embodiments of the disclosed subject matter. In some embodiments, the base station 500 can be a 5G or other NR base station (e.g., gNB or other NR-type or xG base station, wherein x can be a number greater than 5). In other embodiments, the base station 500 can be a 4G or LTE base station, or some other type of base station (e.g., other type of access point).

With regard to a 5G or other NR base station, the base station 500 can comprise a CU-CP node 502 (e.g., a gNB or other NR-NB CU-CP node), one or more DUs (e.g., a gNB or other NR-NB DUs), including DU 504, a desired number of CU-UP nodes (e.g., a gNB or other NR-NB CU-UP nodes), including CU-UP nodes 506, 508, and 510, and/or other network equipment. The CU-CP node 502 can be associated or interfaced with the DUs (e.g., DU 504) via an interface (e.g., F1-C interface) or connection. The CU-CP node 502 can be associated or interfaced with the CU-UP nodes (e.g., CU-UP nodes 506, 508, and 510) via an interface (e.g., E1 interface) or connection. The CU-UP nodes (e.g., CU-UP nodes 506, 508, and 510) can be associated or interfaced with the one or more DUs (e.g., DU 504) via an interface (e.g., F1-U interface) or connection.

A DU (e.g., DU 504) can provide support for lower layers of a protocol stack. For instance, a DU (e.g., DU 504) can be a logical node that can host or handle baseband (e.g., PHY) and L2 (e.g., MAC and RLC layer) functionality associated with the base station 500. A CU-UP node (e.g., CU-UP node 506, 508, or 510) can be a logical node that can host or handle data traffic between the core network 104 (e.g., 5G or other NR or xG core network) and the DU(s) (e.g., DU 504) to which the particular CU-UP is connected. The CU-CP node 502 can be a logical node that can host or handle L3 (e.g., RRC and packet data convergence protocol (PDCP) layer) control plane functionality associated with the base station 500.

In some embodiments, a device(s) (e.g., device(s) 116 and/or 118) can be connected to the base station 500, via the DU 504, wherein one or more CU-UP nodes (e.g., CU-UP nodes 506, 508, and/or 510) and the DU 504 can be serving the device by performing or facilitating performing downlink data transfers of downlink data to the device from a data source (e.g., a service and/or another device, or a network component of the communication network 102 or core network 104 (e.g., via the UPF node)), and uplink data transfers of uplink data from the device to a desired destination (e.g., the data source) via the base station 500.

The base station 500 can receive and transmit signal(s) from and to wireless devices like access points (e.g., base stations, femtocells, picocells, or other type of access point), access terminals (e.g., UEs), wireless ports and routers, and the like, through a set of antennas 5691-569R. In an aspect, the antennas 5691-569R can be a part of a communication platform 512, which can comprise electronic components and associated circuitry that can provide for processing and manipulation of received signal(s) and signal(s) to be transmitted. In an aspect, the communication platform 512 can include a receiver/transmitter 514 that can convert signal from analog to digital upon reception, and from digital to analog upon transmission. In addition, receiver/transmitter 514 can divide a single data stream into multiple, parallel data streams, or perform the reciprocal operation. In accordance with various embodiments, the communication platform 512 can be, can comprise, or can be associated with an RU(s) (e.g., a gNB or other NR-NB RU node(s)).

In an aspect, coupled to receiver/transmitter 514 can be a multiplexer/demultiplexer (mux/demux) 516 that can facilitate manipulation of signal in time and frequency space. The mux/demux 516 can multiplex information (e.g., data/traffic and control/signaling) according to various multiplexing schemes such as, for example, time division multiplexing (TDM), frequency division multiplexing (FDM), orthogonal frequency division multiplexing (OFDM), code division multiplexing (CDM), space division multiplexing (SDM), etc. In addition, mux/demux component 516 can scramble and spread information (e.g., codes) according to substantially any code known in the art, e.g., Hadamard-Walsh codes, Baker codes, Kasami codes, polyphase codes, and so on. A modulator/demodulator (mod/demod) 518 also can be part of the communication platform 512, and can modulate information according to multiple modulation techniques, such as frequency modulation, amplitude modulation (e.g., M-ary quadrature amplitude modulation (QAM), with M a positive integer), phase-shift keying (PSK), and the like.

The base station 500 also can comprise a processor(s) 520 that can be configured to confer and/or facilitate providing functionality, at least partially, to substantially any electronic component in or associated with the base station 500. For instance, the processor(s) 520 can facilitate operations on data (e.g., symbols, bits, or chips) for multiplexing/demultiplexing, modulation/demodulation, such as effecting direct and inverse fast Fourier transforms, selection of modulation rates, selection of data packet formats, inter-packet times, and/or other operations on data, such as described herein.

In another aspect, the base station 500 can include a data store 522 that can store data structures; code instructions; rate coding information; information relating to measurement of radio link quality or reception of information related thereto; information relating to devices, communication conditions or performance indicators associated with devices (e.g., signal-to-interference-plus-noise ratio (SINR), reference signal received power (RSRP), reference signal received quality (RSRQ), channel quality indicator (CQI), and/or other wireless communications metrics or parameters) associated with devices, metadata, policies and rules, users, applications, services, files, services, communication networks, RANs, cells, LCP, allowed logical channel data, allowed logical channels, restricted logical channels, resources, congestion information or indicators, PDU session data, congestion levels, threshold values or levels (e.g., threshold congestion level), data processing operations, messages, notifications, alarms, alerts, preferences (e.g., user or client preferences), hash values, metadata, parameters, traffic flows, policies, the defined LCP management criteria, algorithms (e.g., enhanced LCP management algorithms, uplink grant scheduling algorithm(s), downlink scheduling algorithm(s), hash algorithms, data compression algorithms, data decompression algorithms, and/or other algorithm), interfaces, protocols, interfaces, tools, and/or other information; white list information, information relating to managing or maintaining the white list; system or device information like policies and specifications; code sequences for scrambling; spreading and pilot transmission; floor plan configuration; base station deployment and frequency plans; scheduling policies; and so on. The processor(s) 520 can employ one or more processors (e.g., one or more CPUs), microprocessors, or controllers) that can process information, and can be coupled to the data store 522 in order to store and retrieve at least some of the information (e.g., information, such as algorithms, relating to multiplexing/demultiplexing or modulation/demodulation; information relating to radio link levels; information relating to devices, communication conditions associated with devices, metadata, communication devices, policies and rules, users, data, files, services, applications, communication networks, RANs, cells, LCP, allowed logical channel data, allowed logical channels, restricted logical channels, resources, congestion information or indicators, PDU session data, congestion levels, threshold values or levels (e.g., threshold congestion level), data processing operations, messages, notifications, alarms, alerts, preferences (e.g., user or client preferences), hash values, metadata, parameters, traffic flows, policies, the defined LCP management criteria, algorithms (e.g., enhanced LCP management algorithms, uplink grant scheduling algorithm(s), downlink scheduling algorithm(s), hash algorithms, data compression algorithms, data decompression algorithms, and/or other algorithm), interfaces, protocols, interfaces, tools, and/or other information) desired to operate and/or confer functionality to the communication platform 512 and/or other operational components of the base station 500. The data store 522 can comprise volatile memory and/or nonvolatile memory, such as described herein.

In accordance with various embodiments, the base station 500 (e.g., the DU 504 of the base station 500) can comprise or be associated with the channel manager component 134 that can that can desirably (e.g., automatically, dynamically, suitably, reliably, efficiently, enhancedly, and/or optimally) perform and manage LCP, mitigate congestion in one or more RANs (e.g., CU-UPs or other components) of the communication network, mitigate wastage of resources, and mitigate discarding of data (e.g., data packets of PDU sessions or other data) when there is congestion in the RAN(s) (e.g., congestion in the CU-UP(s) of the RAN), such as described herein.

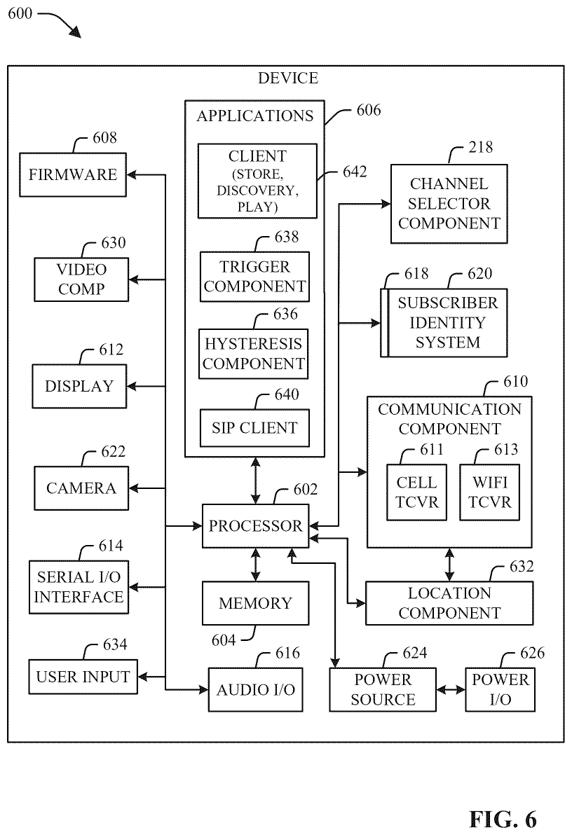

Referring to FIG. 6, FIG. 6 illustrates a diagram of a non-limiting example device 600 (e.g., wireless or mobile phone, electronic pad or tablet, electronic eyewear, electronic watch, other electronic bodywear, IoT device, or other type of communication device or UE) that can be operable to engage in a system architecture that facilitates wireless communications according to one or more embodiments described herein, in accordance with various aspects and embodiments of the disclosed subject matter. Although a device is illustrated herein, it will be understood that other devices can be a communication device, and that the device 600 is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the disclosed subject matter also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device, such as the device 600, can typically include a variety of machine-readable media. Machine-readable media can be any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, solid state drive (SSD) or other solid-state storage technology, Compact Disk Read Only Memory (CD ROM), digital video disk (DVD), Blu-ray disk, or other optical disk storage, magnetic cassettes, magnetic tape, magnetic disk storage or other magnetic storage devices, or any other medium which can be used to store the desired information and which can be accessed by the computer. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of the any of the above should also be included within the scope of computer-readable media.

The device 600 can include a processor(s) 602 for controlling and processing all onboard operations and functions. The processor(s) 602 can comprise one or more processors (e.g., one or more central processing units (CPUs)), microprocessors, or controllers) that can process information associated with the device 600. A memory 604 can interface to the processor(s) 602 for storage of data and one or more applications 606 (e.g., a video player software, user feedback component software, etc.). Other applications can include voice recognition of predetermined voice commands that facilitate initiation of the user feedback signals. The applications 606 can be stored in the memory 604 and/or in a firmware 608, and executed by the processor(s) 602 from either or both the memory 604 or/and the firmware 608. The firmware 608 can also store startup code for execution in initializing the device 600. A communication component 610 interfaces to the processor(s) 602 to facilitate wired/wireless communication with external systems, e.g., cellular networks, VoIP networks, and so on. Here, the communication component 610 can also include a suitable cellular transceiver 611 (e.g., a global system for mobile communication (GSM), orthogonal frequency division multiple access (OFDMA), 4G, LTE, 5G, other NR, or other type of transceiver) and/or an unlicensed transceiver 613 (e.g., Wi-Fi, WiMax) for corresponding signal communications. The device 600 can be a device such as a cellular telephone, a PDA with mobile communications capabilities, and messaging-centric devices. The communication component 610 also facilitates communications reception from terrestrial radio networks (e.g., broadcast), digital satellite radio networks, and Internet-based radio services networks.

The device 600 includes a display 612 for displaying text, images, video, telephony functions (e.g., a Caller ID function), setup functions, and for user input. For example, the display 612 can also be referred to as a “screen” that can accommodate the presentation of multimedia content (e.g., music metadata, messages, wallpaper, graphics, etc.). The display 612 can also display videos and can facilitate the generation, editing and sharing of video quotes. A serial I/O interface 614 is provided in communication with the processor(s) 602 to facilitate wired and/or wireless serial communications (e.g., USB, and/or IEEE 1394) through a hardwire connection, and other serial input devices (e.g., a keyboard, keypad, and mouse). This supports updating and troubleshooting the device 600, for example. Audio capabilities are provided with an audio I/O component 616, which can include a speaker for the output of audio signals related to, for example, indication that the user pressed the proper key or key combination to initiate the user feedback signal. The audio I/O component 616 also facilitates the input of audio signals through a microphone to record data and/or telephony voice data, and for inputting voice signals for telephone conversations.

The device 600 can include a slot interface 618 for accommodating a SIC (Subscriber Identity Component) in the form factor of a card Subscriber Identity Module (SIM) or universal SIM 620, and interfacing the SIM card 620 with the processor(s) 602. However, it is to be appreciated that the SIM card 620 can be manufactured into the device 600, and updated by downloading data and software.

The device 600 can process IP data traffic through the communication component 610 to accommodate IP traffic from an IP network such as, for example, the Internet, a corporate intranet, a home network, a person area network, etc., through an ISP or broadband cable provider. Thus, VoIP traffic can be utilized by the device 600 and IP-based multimedia content can be received in either an encoded or a decoded format.

A video processing component 622 (e.g., a camera) can be provided for decoding encoded multimedia content. The video processing component 622 can aid in facilitating the generation, editing, and sharing of video quotes. The device 600 also includes a power source 624 in the form of batteries and/or an AC power subsystem, which power source 624 can interface to an external power system or charging equipment (not shown) by a power I/O component 626.

The device 600 can also include a video component 630 for processing video content received and, for recording and transmitting video content. For example, the video component 630 can facilitate the generation, editing and sharing of video quotes. A location tracking component 632 facilitates geographically locating the device 600. As described hereinabove, this can occur when the user initiates the feedback signal automatically or manually. A user input component 634 facilitates the user initiating the quality feedback signal. The user input component 634 can also facilitate the generation, editing and sharing of video quotes. The user input component 634 can include such conventional input device technologies such as a keypad, keyboard, mouse, stylus pen, and/or touch screen, for example.

Referring again to the applications 606, a hysteresis component 636 facilitates the analysis and processing of hysteresis data, which is utilized to determine when to associate with the access point. A software trigger component 638 can be provided that facilitates triggering of the hysteresis component 636 when the Wi-Fi transceiver 613 detects the beacon of the access point. A SIP client 640 enables the device 600 to support SIP protocols and register the subscriber with the SIP registrar server. The applications 606 can also include a client 642 that provides at least the capability of discovery, play and store of multimedia content, for example, music.

The device 600, as indicated above related to the communication component 610, includes an indoor network radio transceiver 613 (e.g., Wi-Fi transceiver). This function supports the indoor radio link, such as IEEE 802.11, for the dual-mode GSM device (e.g., device 600). The device 600 can accommodate at least satellite radio services through a device (e.g., handset device) that can combine wireless voice and digital radio chipsets into a single device (e.g., single handheld device).

In some embodiments, the device 600 can comprise the channel selector component 218 that can determine and select one or more allowed logical channels for an uplink grant for an uplink data transmission to the base station, and can determine and not select one or more restricted logical channels that can be restricted from use for the uplink grant, based at least in part on the results of analyzing allowed logical channel data that can be received from the channel manager component 134 (e.g., of the DU 120), such as described herein.

It is to be appreciated and understood that one or more components (e.g., the devices, discard manager component, base station, core network, or other component) of the systems (e.g., system 100, system 200, system 400, or other system) or methods described herein can comprise or be associated with various other types of components, such as display screens (e.g., touch screen displays or non-touch screen displays), audio functions (e.g., amplifiers, speakers, or audio interfaces), or other interfaces, to facilitate presentation of information to users, entities, or other components (e.g., other devices or other servers), and/or to perform other desired functions or operations.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

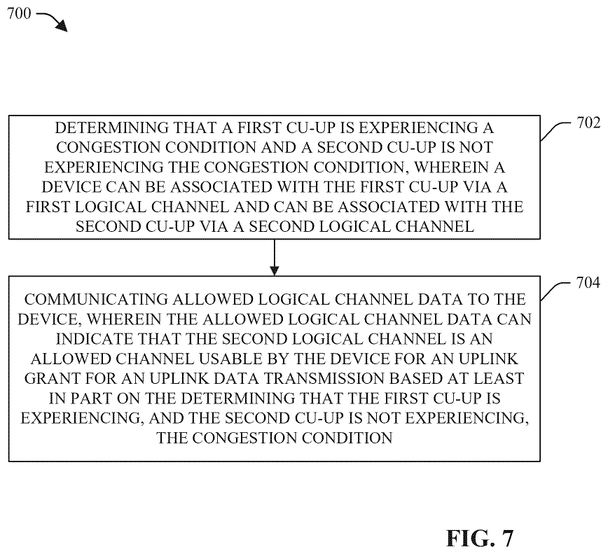

In view of the example systems and/or devices described herein, example methods that can be implemented in accordance with the disclosed subject matter can be further appreciated with reference to flowcharts in FIGS. 7-9. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 7 illustrates a flow chart of an example method 700 that can desirably (e.g., automatically, dynamically, suitably, reliably, efficiently, enhancedly, and/or optimally) perform and manage LCP, and manage and mitigate congestion of CU-UPs in a RAN of a communication network, in accordance with various aspects and embodiments of the disclosed subject matter. The method 700 can be employed by, for example, a system comprising the channel manager component, which can comprise or be associated with the processor component, the data store, and/or other components.

At 702, a determination can be made that a first CU-UP is experiencing a congestion condition and a second CU-UP is not experiencing the congestion condition, wherein a device can be associated with the first CU-UP via a first logical channel and can be associated with the second CU-UP via a second logical channel. Via a connection of the device to the DU associated with the first CU-UP and the second CU-UP, the device can be associated with (e.g., connected to) the first CU-UP via the first logical channel and the second CU-UP via the second logical channel. The channel manager component can employ the congestion detector component to determine or detect when a CU-UP is experiencing a congestion condition. For instance, the first CU-UP can be experiencing the congestion condition, wherein a congestion component of the first CU-UP can detect that the first CU-UP is experiencing the congestion condition. The congestion component of the first CU-UP can communicate a congestion indicator indicating congestion to the DU. Based at least in part on the congestion indicator received from the first CU-UP, the congestion detector component (e.g., of the channel manager component of the DU) can determine or detect that the first CU-UP is experiencing the congestion condition. The congestion detector component also can determine that the second CU-UP is not experiencing the congestion condition based at least in part on the DU not receiving a congestion indicator indicating congestion from the second CU-UP.

At 704, allowed logical channel data can be communicated to the device, wherein the allowed logical channel data can indicate that the second logical channel is an allowed channel usable by the device for an uplink grant for an uplink data transmission based at least in part on the determining that the first CU-UP is experiencing, and the second CU-UP is not experiencing, the congestion condition. The channel manager component can determine and generate the allowed logical channel data that can indicate the second logical channel is an allowed channel usable by the device for an uplink grant for an uplink data transmission, based at least in part on the determining that the first CU-UP is experiencing, and the second CU-UP is not experiencing, the congestion condition. The allowed logical channel data also can indicate that the first logical channel is a disallowed logical channel based at least in part on the absence of first logical channel information relating to the first logical channel from the allowed logical channel data, wherein such absence of the first logical channel information from the allowed logical channel data can indicate that the first logical channel is not an allowed logical channel with respect to the device. The channel manager component can communicate the allowed logical channel data to the device. Based at least in part on the allowed logical channel data indicating that the second logical channel is the allowed logical channel, and the first logical channel is a disallowed logical channel, when the device receives the uplink grant, the device can utilize the second logical channel for the uplink grant for the uplink transmission of data, and will not use the first logical channel for the uplink grant.

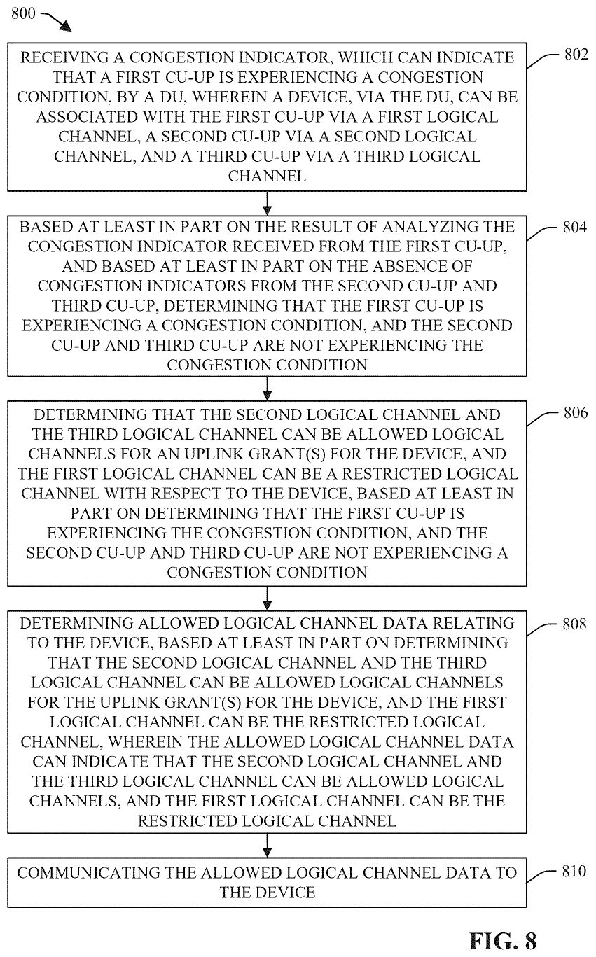

FIG. 8 depicts a flow chart of another example method 800 that can desirably (e.g., automatically, dynamically, suitably, reliably, efficiently, enhancedly, and/or optimally) perform and manage LCP, and manage and mitigate congestion of CU-UPs in a RAN of a communication network, in accordance with various aspects and embodiments of the disclosed subject matter. The method 800 can be employed by, for example, a system comprising the channel manager component, which can comprise or be associated with the processor component, the data store, and/or other components.

At 802, a congestion indicator, which can indicate that a first CU-UP is experiencing a congestion condition, can be received by a DU, wherein a device, via the DU, can be associated with the first CU-UP via a first logical channel, a second CU-UP via a second logical channel, and a third CU-UP via a third logical channel. This example method 800 can relate to a non-limiting example scenario where the device can be associated with (e.g., connected to) the DU (e.g., DU comprising the channel manager component). The device, via the association with the DU, can be associated with (e.g., connected to) the first CU-UP via the first logical channel, the second CU-UP via a second logical channel, and the third CU-UP via the third logical channel (e.g., with regard to one or more services being utilized by the device). The channel manager component (e.g., the DU), employing the congestion detector component, receive the congestion indicator from the first CU-UP.

At 804, based at least in part on the result of analyzing the congestion indicator received from the first CU-UP, and based at least in part on the absence of congestion indicators from the second CU-UP and the third CU-UP, a determination can be made that the first CU-UP is experiencing a congestion condition, and the second CU-UP and the third CU-UP are not experiencing the congestion condition. Based at least in part on the result of analyzing the congestion indicator received from the first CU-UP, the congestion detector component can determine or detect that the first CU-UP is experiencing the congestion condition. Based at least in part on the absence of congestion indicators from the second CU-UP and the third CU-UP, the congestion detector component also can determine that the second CU-UP and the third CU-UP are not experiencing the congestion condition.

At 806, a determination can be made that the second logical channel and the third logical channel can be allowed logical channels for an uplink grant(s) for the device, and the first logical channel can be a restricted logical channel (e.g., restricted from use for the uplink grant(s)) with respect to the device, based at least in part on determining that the first CU-UP is experiencing the congestion condition, and the second CU-UP and third CU-UP are not experiencing a congestion condition. The channel manager component can determine that the second logical channel and the third logical channel can be allowed logical channels for the uplink grant(s) for the device, and the first logical channel can be the restricted (e.g., disallowed) logical channel, with respect to the device, based at least in part on determining that the first CU-UP is experiencing the congestion condition, and the second CU-UP and third CU-UP are not experiencing a congestion condition.

At 808, allowed logical channel data relating to the device can be determined, based at least in part on determining that the second logical channel and the third logical channel can be allowed logical channels for the uplink grant(s) for the device, and the first logical channel can be the restricted logical channel, wherein the allowed logical channel data can indicate that the second logical channel and the third logical channel can be allowed logical channels, and the first logical channel can be the restricted logical channel. Based at least in part on determining that the second logical channel and the third logical channel can be allowed logical channels, and the first logical channel can be the restricted logical channel, the channel manager component can determine and generate the allowed logical channel data relating to the device, wherein the allowed logical channel data can indicate that the second logical channel and the third logical channel can be the allowed logical channels for use for the uplink grant(s) by the device (e.g., to communicate uplink data), and the first logical channel can be the restricted logical channel that can be restricted from use for the uplink grant(s). In some embodiments, the allowed logical channel data can comprise second logical channel information relating to the second logical channel and third logical channel information relating to the third logical channel that can indicate or specify the second logical channel and the third logical channel are allowed logical channels that can be utilized by the device for the uplink grant(s), wherein absence of first logical channel information relating to the first logical channel from the allowed logical channel data can indicate that the first logical channel is the restricted logical channel with respect to the device.

At 810, the allowed logical channel data can be communicated to the device. The channel manager component can communicate or facilitate communication the allowed logical channel data from the DU to the device. The device can analyze the allowed logical channel data. Based at least in part on the results of analyzing the allowed logical channel data, the device can determine that the second logical channel and the third logical channel can be the allowed logical channels for use for the uplink grant(s) by the device (e.g., to communicate uplink data), and the first logical channel can be the restricted logical channel that can be restricted from use for the uplink grant(s) by the device.

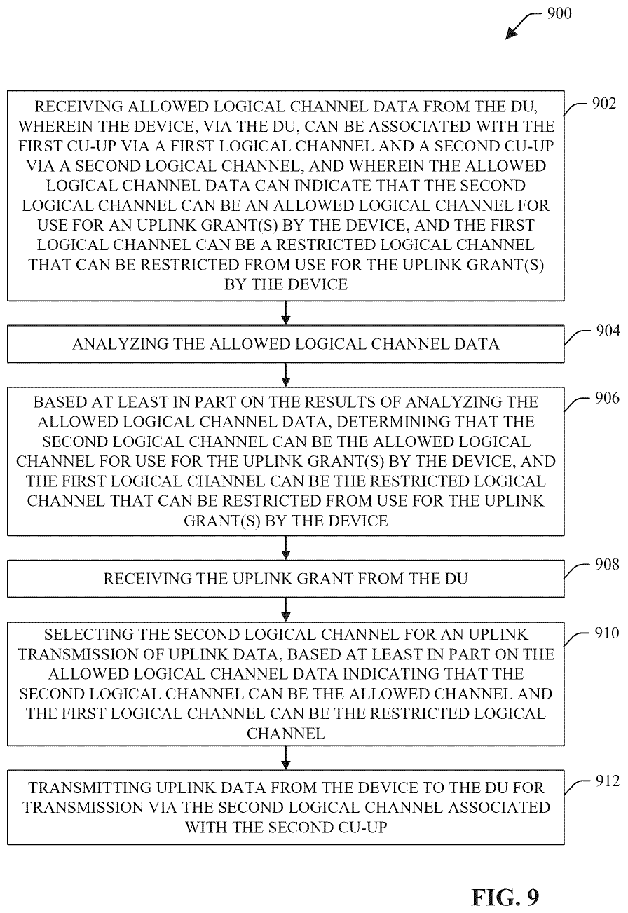

FIG. 9 illustrates a flow chart of an example method 900 that can desirably (e.g., automatically, dynamically, suitably, reliably, efficiently, enhancedly, and/or optimally) determine and select an allowed logical channel(s) associated with a CU-UP(s) (e.g., associated with a device) that can be utilized for an uplink grant for an uplink data transmission, and not select a restricted logical channel(s) associated with another CU-UP(s) (e.g., associated with the device), to facilitate mitigating congestion in the other CU-UP(s), in accordance with various aspects and embodiments of the disclosed subject matter. The method 900 can be employed by, for example, a system (e.g., a device comprising the system) comprising the channel selector component, which can comprise or be associated with the processor component, the data store, and/or other components.

At 902, allowed logical channel data can be received from the DU, wherein the device, via the DU, can be associated with the first CU-UP via a first logical channel and a second CU-UP via a second logical channel, and wherein the allowed logical channel data can indicate that the second logical channel can be an allowed logical channel for use for an uplink grant(s) by the device, and the first logical channel can be a restricted logical channel that can be restricted from use for the uplink grant(s) by the device. The device, via the association with (e.g., connection to) the DU, can be associated with (e.g., connected to) the first CU-UP via the first logical channel and the second CU-UP via a second logical channel (e.g., with regard to one or more services being utilized by the device).

The DU, employing the channel manager component, can determine that the second logical channel can be the allowed logical channel for use for the uplink grant(s) by the device, and the first logical channel can be the restricted logical channel that can be restricted from use for the uplink grant(s) by the device, based at least in part on congestion information (e.g., congestion indicator received from the first CU-UP) that can indicate that the first CU-UP can be experiencing a congestion condition and the second CU-UP is not experiencing a congestion condition. The channel manager component can generate the allowed logical channel data that can indicate that the second logical channel can be the allowed logical channel, and the first logical channel can be the restricted logical, with respect to the device. For instance, the allowed logical channel data can comprise second logical channel information relating to the second logical channel that can indicate the second logical channel can be the allowed channel for use for the uplink grant(s) by the device, and can omit first logical channel information relating to the first logical channel from the allowed logical channel data, wherein the omission of the first logical channel information from the allowed logical channel data can indicate that the first logical channel can be the restricted channel that can be restricted from use for the uplink grant(s) by the device. The DU can communicate the allowed logical channel data to the device, which can receive the allowed logical channel data.

At 904, the allowed logical channel data can be analyzed. At 906, based at least in part on the results of analyzing the allowed logical channel data, a determination can be made that the second logical channel can be the allowed logical channel for use for the uplink grant(s) by the device, and the first logical channel can be the restricted logical channel that can be restricted from use for the uplink grant(s) by the device. For instance, based at least in part on the results of analyzing the allowed logical channel data, the device, employing the channel selector component, can determine that the second logical channel can be the allowed logical channel for use for the uplink grant(s) by the device, and the first logical channel can be the restricted logical channel that can be restricted (e.g., disallowed) from use for the uplink grant(s) by the device.

At 908, the uplink grant can be received from the DU. The device can receive the uplink grant from the DU.

At 910, the second logical channel can be selected for an uplink transmission of uplink data, based at least in part on the allowed logical channel data indicating that the second logical channel can be the allowed channel and the first logical channel can be the restricted logical channel. At 912, uplink data can be transmitted from the device to the DU for transmission via the second logical channel associated with the second CU-UP. The device, employing the channel selector component, can select the second logical channel for the uplink transmission of the uplink data (and can determine that the first logical channel is not to be selected), based at least in part on the allowed logical channel data indicating that the second logical channel can be the allowed channel and the first logical channel can be the restricted logical channel. The device can transmit the uplink data from the device to the DU for transmission via the second logical channel associated with the second CU-UP.

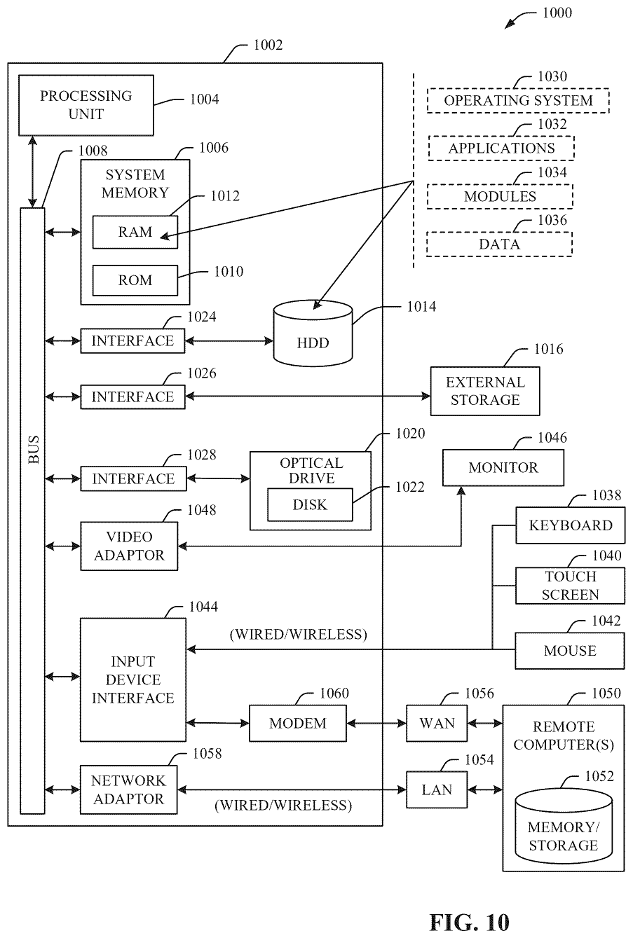

In order to provide additional context for various embodiments described herein, FIG. 10 and the following discussion are intended to provide a brief, general description of a suitable computing environment 1000 in which the various embodiments of the embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 also can be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056, e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer-readable storage media can include but are not limited to magnetic storage devices (e.g., hard disk, floppy disk, magnetic strips, etc.), optical discs (e.g., compact disc (CD), digital versatile disc (DVD), blu-ray disc (BD), etc.), smart cards, and memory devices comprising volatile memory and/or non-volatile memory (e.g., flash memory devices, such as, for example, card, stick, key drive, etc.), or the like. In accordance with various implementations, computer-readable storage media can be non-transitory computer-readable storage media and/or a computer-readable storage device can comprise computer-readable storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. A processor can be or can comprise, for example, multiple processors that can include distributed processors or parallel processors in a single machine or multiple machines. Additionally, a processor can comprise or refer to an integrated circuit, an application specific integrated circuit (ASIC), a digital signal processor (DSP), a programmable gate array (PGA), a field programmable gate array (FPGA), a programmable logic controller (PLC), a complex programmable logic device (CPLD), a state machine, a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

A processor can facilitate performing various types of operations, for example, by executing computer-executable instructions. When a processor executes instructions to perform operations, this can include the processor performing (e.g., directly performing) the operations and/or the processor indirectly performing operations, for example, by facilitating (e.g., facilitating operation of), directing, controlling, or cooperating with one or more other devices or components to perform the operations. In some implementations, a memory can store computer-executable instructions, and a processor can be communicatively coupled to the memory, wherein the processor can access or retrieve computer-executable instructions from the memory and can facilitate execution of the computer-executable instructions to perform operations.

In certain implementations, a processor can be or can comprise one or more processors that can be utilized in supporting a virtualized computing environment or virtualized processing environment. The virtualized computing environment may support one or more virtual machines representing computers, servers, or other computing devices. In such virtualized virtual machines, components such as processors and storage devices may be virtualized or logically represented.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in this application, the terms “component,” “system,” “platform,” “framework,” “layer,” “interface,” “agent,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, computer-executable instructions, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

A communication device, such as described herein, can be or can comprise, for example, a computer, a laptop computer, a server, a phone (e.g., a smart phone), an electronic pad or tablet, an electronic gaming device, electronic headwear or bodywear (e.g., electronic eyeglasses, smart watch, augmented reality (AR)/virtual reality (VR) headset, or other type of electronic headwear or bodywear), a set-top box, an Internet Protocol (IP) television (IPTV), IoT device (e.g., medical device, electronic speaker with voice controller, camera device, security device, tracking device, appliance, or other IoT device), or other desired type of communication device.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be appreciated and understood that components (e.g., device, UE, communication network, core network, RAN, base station, channel manager component, congestion component, channel selector component, processor component, data store, or other component), as described with regard to a particular system or method, can include the same or similar functionality as respective components (e.g., respectively named components or similarly named components) as described with regard to other systems or methods disclosed herein.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method, comprising:
determining, by a system comprising at least one processor, that a first central unit user plane node is experiencing a congestion condition and a second central unit user plane node is not experiencing the congestion condition, wherein a device is associated with the first central unit user plane node via a first logical channel and is associated with the second central unit user plane node via a second logical channel; and
communicating, by the system, allowed logical channel data to the device, wherein the allowed logical channel data indicates that the second logical channel is an allowed channel usable by the device for an uplink grant for an uplink data transmission based on the determining that the first central unit user plane node is experiencing, and the second central unit user plane node is not experiencing, the congestion condition.

2. The method of claim 1, wherein the uplink data transmission is a second uplink data transmission, wherein the allowed logical channel data comprises second logical channel information that indicates the second logical channel is the allowed channel, wherein the allowed logical channel data does not comprise first logical channel information, and wherein absence of the first logical channel information from the allowed logical channel data indicates that use of the first logical channel for the uplink grant for a first uplink data transmission by the device is disallowed.

3. The method of claim 1, wherein the uplink data transmission is a second uplink data transmission, and wherein the method further comprises:
determining, by the system, that the second logical channel is the allowed channel usable by the device for the uplink grant for the second uplink data transmission to the second central unit user plane node based on determining that the second central unit user plane node is not experiencing the congestion condition; and
determining, by the system, that the first logical channel is a disallowed channel that is not to be used by the device for the uplink grant for a first uplink data transmission to the first central unit user plane node based on the determining that the first central unit user plane node is experiencing the congestion condition.

4. The method of claim 3, further comprising:
determining, by the system, that uplink grant scheduling for the device with regard to the first logical channel is to be deprioritized and use of the first logical channel by the device is to be restricted, based on the determining that the first central unit user plane node is experiencing the congestion condition.

5. The method of claim 1, further comprising:
determining, by the system, update information, comprising the allowed logical channel data, based on determining that the second central unit user plane node is not experiencing the congestion condition and based on the determining that the first central unit user plane node is experiencing the congestion condition,
wherein the communicating comprises communicating the update information, comprising the allowed logical channel data, to the device, via a control signal, to inform the device that the second logical channel is the allowed channel and the first logical channel is disallowed.

6. The method of claim 5, wherein the control signal is a medium access control-control element signal or a radio resource control signal.

7. The method of claim 5, wherein the allowed channel is a second allowed channel, wherein the uplink data transmission is a second uplink data transmission, and wherein the method further comprises:
determining, by the system, that a third central unit user plane node is not experiencing the congestion condition, wherein the device is associated with the third central unit user plane node via a third logical channel; and
determining, by the system, that the allowed logical channel data is to indicate the third logical channel is a first allowed channel usable by the device for the uplink grant for a first uplink data transmission based on determining that the third central unit user plane node is not experiencing the congestion condition,
wherein the communicating of the update information comprises communicating the update information, comprising the allowed logical channel data, to the device, via the control signal, to inform the device that the second logical channel is the second allowed channel, the third logical channel is the first allowed channel, and the first logical channel is disallowed.

8. The method of claim 5, wherein the allowed logical channel data is first allowed logical channel data, wherein the update information is first update information, wherein the allowed channel is a second allowed channel, wherein the uplink grant is a first uplink grant, wherein the uplink data transmission is a second uplink data transmission, wherein the control signal is a first control signal, and wherein the method further comprises:
receiving, by the system, congestion resolution information that indicates the congestion condition associated with the first central unit user plane node has been resolved;
determining, by the system, second update information, comprising second allowed logical channel data, wherein the second allowed logical channel data indicates that the first logical channel is a first allowed channel usable by the device for a second uplink grant for a first uplink data transmission, and the second logical channel is the second allowed channel usable by the device for the second uplink grant for a third uplink data transmission; and
communicating, by the system, the second update information, comprising the second allowed logical channel data, to the device, via a second control signal, to inform the device that the first logical channel and the second logical channel are allowed channels usable by the device for the second uplink grant.

9. A system, comprising:
at least one memory that stores computer executable components; and
at least one processor that executes computer executable components stored in the at least one memory, wherein the computer executable components comprise:
a congestion detector that determines a first central unit user plane node is experiencing a congestion condition and a second central unit user plane node is not experiencing the congestion condition, wherein a user equipment is connected to the first central unit user plane node via a first channel and is connected to the second central unit user plane node via a second channel; and
a channel manager that communicates allowed channel data to the user equipment, wherein the allowed channel data indicates that the second channel is an allowed channel usable by the user equipment for an uplink grant for an uplink data transmission based on the determination that the first central unit user plane node is experiencing, and the second central unit user plane node is not experiencing, the congestion condition.

10. The system of claim 9, wherein the uplink data transmission is a second uplink data transmission, wherein the allowed channel data comprises second channel information that indicates that the second channel is the allowed channel, and wherein the allowed channel data does not comprise first channel information relating to the first channel to indicate that use of the first channel for the uplink grant for a first uplink data transmission by the user equipment is restricted.

11. The system of claim 9, wherein the uplink data transmission is a second uplink data transmission, and wherein the channel manager determines that the second channel is the allowed channel usable by the user equipment for the uplink grant for the second uplink data transmission to the second central unit user plane node based on determining that the second central unit user plane node is not experiencing the congestion condition, and determines that the first channel is a restricted channel that is not to be used by the user equipment for the uplink grant for a first uplink data transmission to the first central unit user plane node based on the determining that the first central unit user plane node is experiencing the congestion condition.

12. The system of claim 9, wherein the channel manager determines update information, comprising the allowed channel data, based on the determination that the first central unit user plane node is experiencing the congestion condition and the second central unit user plane node is not experiencing the congestion condition, and
wherein the channel manager communicates the update information, comprising the allowed channel data, to the user equipment, via a control signal, to notify or instruct the user equipment that the second channel is the allowed channel and the first channel is restricted.

13. The system of claim 12, wherein the control signal is a layer 2 control signal or a layer 3 control signal.

14. The system of claim 12, wherein the allowed channel is a second allowed channel, wherein the uplink data transmission is a second uplink data transmission,
wherein the channel manager determines that a third central unit user plane node is not experiencing the congestion condition, wherein the user equipment is associated with the third central unit user plane node via a third channel,
wherein the channel manager determines that the allowed channel data is to indicate the third channel is a first allowed channel usable by the user equipment for the uplink grant for a first uplink data transmission based on determining that the third central unit user plane node is not experiencing the congestion condition, and
wherein the channel manager communicates the update information, comprising the allowed channel data, to the user equipment, via the control signal, to notify or instruct the user equipment that the second channel is the second allowed channel, the third channel is the first allowed channel, and the first channel is restricted.

15. The system of claim 12, wherein the allowed channel data is first allowed channel data, wherein the update information is first update information, wherein the allowed channel is a second allowed channel, wherein the uplink grant is a first uplink grant, wherein the uplink data transmission is a second uplink data transmission, wherein the control signal is a first control signal,
wherein the channel manager receives congestion resolution information that indicates the congestion condition associated with the first central unit user plane node has been resolved,
wherein the channel manager determines second update information, comprising second allowed channel data, wherein the second allowed channel data indicates that the first channel is a first allowed channel usable by the device for a second uplink grant for a first uplink data transmission, and the second channel is the second allowed channel usable by the device for the second uplink grant for a third uplink data transmission, and
wherein the channel manager communicates the second update information, comprising the second allowed channel data, to the user equipment, via a second control signal, to notify or instruct the user equipment that the first channel and the second channel are allowed channels usable by the user equipment for the second uplink grant.

16. A non-transitory machine-readable medium, comprising executable instructions that, when executed by at least one processor, facilitate performance of operations, comprising:
receiving, from a distributed unit, allowed logical channel data that indicates a second logical channel between a device and a second central unit user plane node is an allowed logical channel, wherein the allowed logical channel data is determined based on a determination that a first central unit user plane node is experiencing, and the second central unit user plane node is not experiencing, an overload condition, and wherein the allowed logical channel data does not contain first logical channel information relating to a first logical channel between the device and the first central unit user plane node to indicate that the first logical channel is restricted; and
in response to receiving an uplink grant, transmitting, via the second logical channel, second data to the second central unit user plane node based on the allowed logical channel data indicating that the second logical channel is the allowed logical channel, wherein the first logical channel is not used to transmit first data from the device to the first central unit user plane node based on the allowed logical channel data indicating that the first logical channel is restricted.

17. The non-transitory machine-readable medium of claim 16, wherein the operations comprise:
determining that the second logical channel is the allowed logical channel and the first logical channel is restricted based on a result of an analysis of the allowed logical channel data.

18. The non-transitory machine-readable medium of claim 16, wherein the operations comprise:
initiating at least one of a first service or a second service;
establishing the first logical channel between the device and the first central unit user plane node to facilitate use of at least one of the first service or the second service; and
establishing the second logical channel between the device and the second central unit user plane node to facilitate use of at least one of the first service or the second service.

19. The non-transitory machine-readable medium of claim 16, wherein the receiving comprises receiving a control signal comprising the allowed logical channel data, and wherein the control signal is a medium access control-control element signal or a radio resource control signal.

20. The non-transitory machine-readable medium of claim 19, wherein the allowed logical channel data is first allowed logical channel data, wherein the allowed channel is a second allowed channel, wherein the uplink grant is a first uplink grant, wherein the determination that the first central unit user plane node is experiencing, and the second central unit user plane node is not experiencing, the overload condition is a first determination, wherein the control signal is a first control signal, and wherein the operations comprise:
receiving, from the distributed unit, a second control signal comprising second allowed logical channel data that indicates the first logical channel is a first allowed logical channel and the second logical channel is the second allowed logical channel, wherein the second allowed logical channel data is determined based on a second determination that the overload condition has been resolved and the first central unit user plane node and the second central unit user plane node are not experiencing the overload condition; and
in response to receiving a second uplink grant:
transmitting, via the first logical channel, the first data to the first central unit user plane node based on the second allowed logical channel data indicating that the first logical channel is the first allowed logical channel; and
transmitting, via the second logical channel, third data to the second central unit user plane node based on the second allowed logical channel data indicating that the second logical channel is the second allowed logical channel.
